(19) United States
(12) Patent Application Publication
(10) Pub. No.: US 2026/0288809 A1
(43) Pub. Date: Sep. 24, 2026

(54) SYSTEM

(71) Applicant: SoftBank Group Corp., Tokyo (JP)

(72) Inventor: Ryo TAKETOMI, Tokyo (JP)

(73) Assignee: SoftBank Group Corp., Tokyo (JP)

(21) Appl. No.: 19/567,028

(22) Filed: Mar. 14, 2026

(30) Foreign Application Priority Data
Mar. 19, 2025 (JP) 2025-045223

(51) Int. Cl. G06F 16/3329; G06F 40/117; G06F 40/289; G06F 40/30

(52) U.S. Cl. CPC G06F 16/33295; G06F 40/117; G06F 40/289; G06F 40/30

(57) ABSTRACT

A system includes a processor that is configured to provide disaster information that is updated in real time based on location information of a user and current weather conditions, analyze a question of the user by using natural language processing technology and input a prompt to a generative AI model to instruct the generative AI model to generate an optimal answer, and recognize an emotional state of the user and use an emotion recognition engine to optimize provision of information.

### CROSS-REFERENCE TO RELATED APPLICATION

This application is based on and claims priority under 35 USC 119 from Japanese Patent Application No. 2025-045223 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional disaster information systems typically provide static or periodically updated information that is not sufficiently tailored to an individual user's current situation, including the user's precise location, real-time weather conditions, and psychological state. As a result, the information provided may be outdated, overly general, or inappropriate for the user's immediate needs during a rapidly evolving disaster event. Furthermore, many existing systems do not provide interactive, natural-language question answering, and do not leverage generative AI models in a controlled manner to generate optimal responses. Additionally, existing systems generally fail to recognize and adapt to the emotional state of the user, such as anxiety, panic, or confusion, which can significantly affect the user's ability to understand and act upon disaster-related guidance. Accordingly, there is a need for a system that can: (i) provide disaster information updated in real time based on the user's location information and current weather conditions, (ii) analyze user questions using natural language processing and generate appropriate prompts for a generative AI model to obtain optimal answers, and (iii) recognize the emotional state of the user and optimize information provision using an emotion recognition engine.

### SUMMARY

In order to solve the above-described problems, an embodiment of the present invention provides a system comprising a processor, wherein the processor is configured to provide disaster information that is updated in real time based on location information of a user and current weather conditions, analyze a question of the user by using natural language processing technology and input a prompt to a generative AI model to instruct the generative AI model to generate an optimal answer, and recognize an emotional state of the user and use an emotion recognition engine to optimize provision of information. In one embodiment, the processor is further configured to input the prompt to the generative AI model and receive the answer from the generative AI model, thereby enabling interactive and context-aware natural-language question answering. In another embodiment, the processor is further configured to automatically collect and analyze past disaster data and weather data and generate a prompt sentence to be input to the generative AI model, so that the generative AI model can generate answers and guidance that are grounded in historical disaster patterns and environmental conditions. By these configurations, the system can provide timely, personalized, and emotionally adaptive disaster information to the user.

The term “system” refers to an integrated combination of hardware and software components, including at least one processor and associated memory, storage, communication interfaces, and application programs, configured to execute the functions described in the claims.

The term “processor” refers to any hardware device or combination of hardware devices capable of executing instructions, such as a central processing unit (CPU), a graphics processing unit (GPU), a digital signal processor (DSP), an application-specific integrated circuit (ASIC), a field-programmable gate array (FPGA), or a system-on-chip (SoC), as well as combinations thereof.

The term “user” refers to a person or entity that operates or interacts with the system, for example by providing input such as questions, allowing acquisition of location information, or receiving disaster information and generated answers.

The term “location information” refers to data indicating a geographical position associated with the user, including but not limited to coordinates such as latitude and longitude, addresses, regions, or positions derived from GPS, cellular networks, Wi-Fi, or other positioning technologies.

The term “current weather conditions” refers to meteorological data representing the present or near-real-time state of the atmosphere at or near the user's location, including but not limited to temperature, precipitation, wind speed, humidity, atmospheric pressure, and issued weather alerts or warnings.

The term “real time” refers to operation in which the system obtains, processes, and updates information with a latency that is sufficiently short for the updated information to be practically current and usable for immediate decision making during a disaster situation.

The term “disaster information” refers to information related to natural or man-made disaster events, including but not limited to earthquakes, typhoons, floods, tsunamis, landslides, storms, and related hazards, as well as warnings, alerts, evacuation recommendations, shelter locations, and safety guidelines.

The term “natural language processing technology” refers to algorithms, models, and techniques for analyzing, interpreting, and processing human language expressed in text or speech, including but not limited to tokenization, parsing, intent detection, classification, entity recognition, and semantic analysis.

The term “question of the user” refers to an input expressed in natural language by the user, requesting information, advice, or guidance related to a disaster situation or disaster preparedness, and provided to the system in textual or spoken form.

The term “generative AI model” refers to an artificial intelligence model configured to generate natural language text or other content based on input data, such as a large language model or other neural network-based generative model trained on linguistic data.

The term “prompt” refers to data, typically in the form of a natural language text string or structured instruction, that is provided as input to the generative AI model in order to specify a task, constrain the response, or guide the generative AI model to generate an answer.

The term “optimal answer” refers to an answer generated by the generative AI model that is appropriate, relevant, and useful in view of the user's question, the user's location information, the current weather conditions, and available disaster information, and that satisfies a predetermined criterion for quality such as accuracy or completeness.

The term “emotional state of the user” refers to a psychological condition of the user, such as anxiety, fear, calmness, confusion, or stress level, which can be inferred from user behavior, voice, text expressions, physiological signals, or other input observable by the system.

The term “emotion recognition engine” refers to a software component, optionally combined with dedicated hardware, that analyzes input data related to the user, such as text, voice, facial expressions, or sensor data, to estimate or classify the emotional state of the user.

The term “optimize provision of information” refers to adjusting the content, format, timing, amount, or delivery style of information provided to the user based on one or more factors, including the user's emotional state, in order to improve comprehensibility, usability, and effectiveness of the information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi®, Bluetooth®, and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

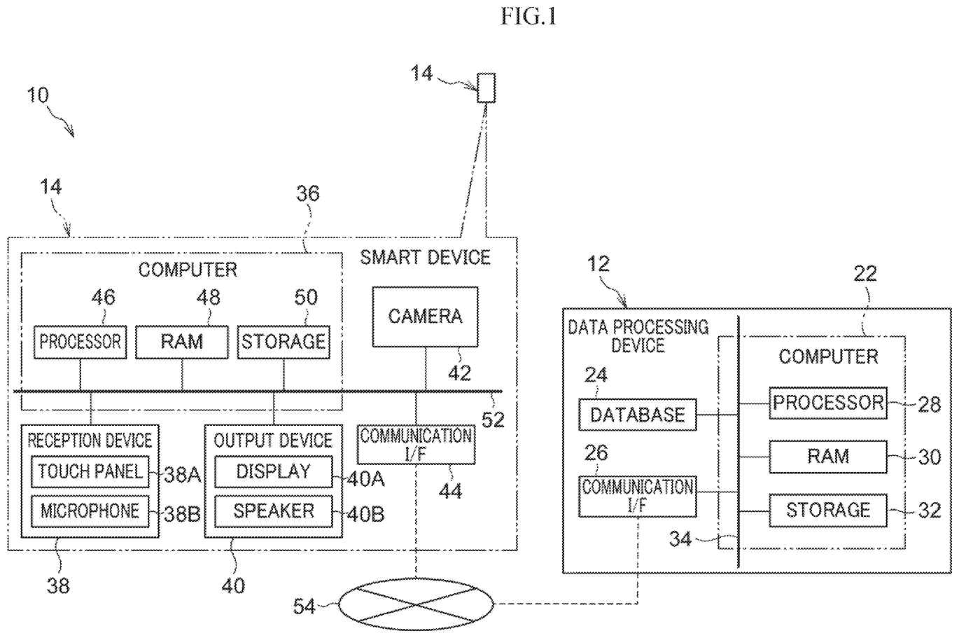

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

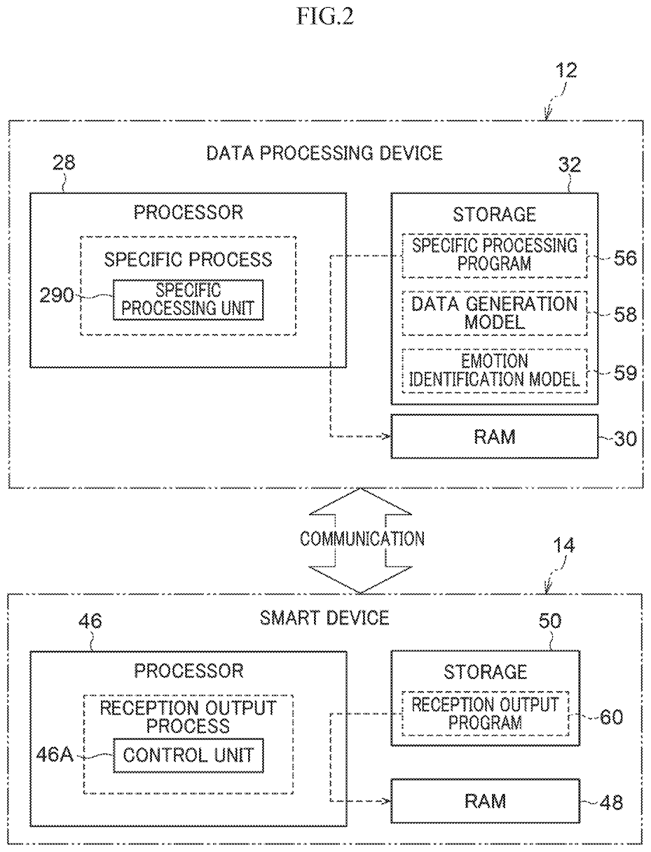

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In disaster-related information systems, conventional architectures typically rely on fixed rule-based decision trees or static retrieval of pre-authored guidance from a database.

Such systems suffer from several technical limitations. First, they lack a dynamic mechanism to translate a user's ambiguous natural language question into a machine-usable representation that can effectively drive downstream data access and response generation. As a result, conventional systems often perform inefficient or overly broad database queries, leading to increased latency, higher computational load, and responses that are either too generic or not contextually appropriate for the user's actual situation.

Second, although large-scale data (such as historical disaster information, weather records, and governmental countermeasure guidelines) is available, existing systems do not integrate such heterogeneous data into a coherent context optimized for input to a generative AI model.

Conventional systems typically pass either raw user input or unstructured document fragments to a generative model without constructing a well-structured prompt sentence that includes role information, constraints, disaster summaries, risk factors, and recommended countermeasures. This results in suboptimal use of computing resources for inference, unstable response quality, and difficulty in ensuring consistency with up-to-date, authoritative data sources.

Third, conventional architectures treat generative models as black boxes and do not include a feedback loop for iteratively optimizing the prompt sentence itself. They do not generate and evaluate multiple candidate prompts based on model-driven or rule-based evaluation indices, thus failing to systematically improve answer quality, robustness, and computational efficiency across a variety of disaster scenarios and user queries.

Fourth, traditional systems do not effectively pre-compute or cache scenario-specific prompts and answer candidates by using continuous or periodic analysis of large disaster and weather datasets. Consequently, every user request is handled from scratch, which increases real-time processing burden, limits scalability during peak demand (for example, during large-scale disasters), and impairs the system's ability to deliver low-latency, context-rich responses.

Fifth, prior systems generally do not incorporate an emotion recognition component into the technical pipeline, and thus cannot adapt the content or level of detail of the generated responses according to the user's emotional state. This leads to a mismatch between interface behavior and the user's cognitive state, potentially increasing user confusion and requiring additional follow-up requests, which in turn increase computational load and network traffic. Accordingly, there is a need for an improved computer-implemented disaster information system that (i) accurately extracts structured intent information from natural language input, (ii) efficiently queries and aggregates heterogeneous disaster-related data, (iii) constructs and optimizes prompt sentences tailored for generative AI models, (iv) leverages pre-generated prompts and answer candidates to reduce real-time computation, and (v) adjusts response content based on recognized user emotions. Such improvements would enhance the overall functioning of the computer system itself by reducing processing overhead, improving response relevance and consistency, and enabling scalable, low-latency operation under variable demand conditions.

The specific processing by the specific processing unit 290 of the data processing device 12 in Example 1 is realized by the following means.

The present invention provides a server comprising a processor, a storage apparatus, a communication interface, and an output interface, the processor being configured to (i) receive, via the communication interface, inquiry information including a natural language question transmitted from a user terminal, and perform text acquisition and normalization on the inquiry information; (ii) analyze the normalized inquiry information by using a natural language processing algorithm and a language representation model to generate structured intent information including at least a disaster type, a temporal situation, a location, a protection target, and a requested information type; (iii) query the storage apparatus, based on the structured intent information, the storage apparatus storing disaster history information, weather history information, countermeasure guideline information, and guideline information provided from public organizations, and select or integrate a plurality of information records according to at least one of time-series relevance, regional relevance, and reliability to produce structured factual data; (iv) construct, based on the structured factual data and the inquiry information, at least one prompt sentence to be supplied to a generative information processing model, the prompt sentence including role designation information, output constraint information, disaster summary information, risk factor information, and recommended countermeasure information; (v) in some embodiments, generate and evaluate a plurality of candidate prompt sentences using at least one of a model-based predictive evaluation index and a rule-based evaluation index, and select a candidate prompt sentence according to an evaluation result; (vi) supply the selected prompt sentence as input to the generative information processing model executed on a computation apparatus, cause the generative information processing model to sequentially generate an answer sentence expressed in natural language, and perform post-processing on the generated answer sentence based on at least one of a safety rule and a formatting rule; (vii) transmit, via the communication interface, the post-processed answer sentence as response information to the terminal, and cause the terminal to output the response information through at least one of a visual output device and an audio output device; and (viii) estimate an emotional state of the user by using an emotion recognition processing unit and adjust at least one of an expression content and a detail level of the prompt sentence or the answer sentence in accordance with the estimated emotional state. This enables improved computer-implemented handling of disaster-related inquiries by converting unstructured natural language questions into optimized prompt sentences and structured data access operations, reducing processing latency and resource consumption, stabilizing the quality and factual consistency of generative model outputs, enabling reuse of pre-generated prompts and answer candidates for anticipated scenarios, and dynamically adapting the generated responses in accordance with the user's emotional state, thereby enhancing both the efficiency and the reliability of the underlying information processing infrastructure.

The term “system” refers to an integrated arrangement of hardware components and software components that collectively execute the processing operations described herein.

The term “server” refers to a computing apparatus or group of computing apparatuses that include at least one processor, a storage apparatus, and a communication interface, and that provide information processing services to one or more terminals over a communication network.

The term “processor” refers to one or more hardware processing units, such as a central processing unit or a graphics processing unit, configured to execute instructions and perform arithmetic and logical operations to implement the functions described in the present specification and claims.

The term “storage apparatus” refers to a physical data storage subsystem, such as a semiconductor memory, a magnetic storage device, an optical storage device, or a combination thereof, configured to store programs, models, disaster-related data, prompt sentences, and answer sentences.

The term “communication interface” refers to a hardware and software interface, such as a network interface controller and associated communication protocol stack, configured to send and receive data over a wired or wireless communication network.

The term “output apparatus” refers to a device or set of devices, including at least one of a display device and an audio output device, configured to present information to a user in a perceptible form.

The term “terminal” refers to a user-operated computing device, such as a mobile device, a portable information terminal, or a personal computer, configured to transmit inquiry information to the server and receive response information from the server.

The term “user” refers to a human operator who interacts with the terminal by inputting inquiries and receiving responses related to disaster information and countermeasures.

The term “inquiry information” refers to data transmitted from the terminal to the server, the data including at least one natural language question and optionally additional metadata such as user identification information, location information, and device information.

The term “natural language question” refers to text expressed in a human language, such as a sentence or a group of sentences, that describes a user's request for disaster-related information or recommended actions.

The term “text data” refers to a sequence of characters encoded in a predetermined character encoding scheme, representing the content of the natural language question or answer sentence.

The term “normalization” refers to a text processing operation that standardizes the representation of text data, including at least one of character conversion, whitespace unification, and punctuation standardization.

The term “natural language processing algorithm” refers to a computational procedure for analyzing or generating human language, including at least one of tokenization, part-of-speech tagging, syntactic parsing, semantic analysis, and intent classification.

The term “language representation model” refers to a machine-learned model configured to map natural language text into internal representations, such as vector representations, that capture semantic or syntactic characteristics of the text.

The term “structured intent information” refers to a machine-readable data structure that represents one or more semantic attributes derived from the natural language question, including at least a disaster type, a temporal situation, a location, a protection target, and a requested information type.

The term “disaster type” refers to a category of event that may cause damage or danger, including at least one of an earthquake, a typhoon, a flood, a landslide, a tsunami, a heavy rain event, and a strong wind event.

The term “temporal situation” refers to time-related context associated with the natural language question, including at least one of a current time period, a past time period, a future time period, and a relative time expression such as “now,” “today,” or “tomorrow.”

The term “location” refers to geographical information associated with the natural language question, including at least one of a region name, a city name, a district name, a coordinate, and a location derived from the terminal.

The term “protection target” refers to an entity or object to be protected from disaster impact, including at least one of a person, a group of persons, an animal, a building, a facility, and property.

The term “requested information type” refers to a classification of the user's requested output, including at least one of safety measures, evacuation procedures, shelter information, damage prediction, and preparation guidelines.

The term “disaster history information” refers to stored data describing past disasters, including at least occurrence time, location, magnitude, impact range, damage details, and associated countermeasures.

The term “weather history information” refers to stored meteorological data relating to past weather conditions, including at least precipitation, wind, temperature, and atmospheric pressure associated with particular times and locations.

The term “countermeasure guideline information” refers to stored information describing recommended actions or procedures to reduce disaster risk or damage, including at least evacuation instructions, preparation checklists, and behavior guidelines.

The term “guideline information provided from public organizations” refers to disaster-related policies, announcements, or instructions issued by governmental bodies, public institutions, or local administrative entities.

The term “information record” refers to a unit of stored data in the storage apparatus, including one or more fields representing disaster-related attributes, and retrievable by the processor in response to a query.

The term “time-series relevance” refers to a measure indicating how closely an information record is related in time to a temporal situation derived from the natural language question.

The term “regional relevance” refers to a measure indicating how closely an information record is related in space to a location derived from the natural language question.

The term “reliability” refers to a measure indicating the degree of trustworthiness or authority of an information record, based on at least one of a data source, an update time, and a verification status.

The term “structured factual data” refers to a collection of one or more information records, organized into a machine-readable form, representing facts relevant to the structured intent information.

The term “prompt sentence” refers to a natural language or model-acceptable sequence of tokens supplied as input to a generative information processing model, the prompt sentence encoding instructions, context, and constraints for generating an answer sentence.

The term “role designation information” refers to an element of a prompt sentence that describes a role or persona to be adopted by the generative information processing model when generating an answer.

The term “output constraint information” refers to an element of a prompt sentence that specifies conditions or limitations on the generated answer sentence, including at least one of length constraints, style constraints, and content constraints.

The term “disaster summary information” refers to a concise description of a disaster-related situation, derived from structured factual data and included in a prompt sentence as context.

The term “risk factor information” refers to data describing potential hazards or risk conditions associated with a disaster, such as flooding probability, building vulnerability, and secondary disaster risk.

The term “recommended countermeasure information” refers to data describing one or more suggested actions or procedures to be taken to reduce or mitigate disaster impact.

The term “generative information processing model” refers to a machine-learned model configured to generate text or other outputs in response to an input prompt sentence, based on parameters learned from training data.

The term “computation apparatus” refers to a hardware component or set of hardware components, including at least one processor and memory, configured to execute the generative information processing model.

The term “candidate prompt sentence” refers to one of a plurality of prompt sentences generated by the processor as alternatives for supplying to the generative information processing model, prior to selection based on an evaluation.

The term “predictive evaluation index” refers to a numerical or categorical measure obtained from a model-based process, including at least an internal score from the generative information processing model, used to evaluate quality or suitability of a candidate prompt sentence.

The term “rule-based evaluation index” refers to a numerical or categorical measure obtained by applying predetermined rules or heuristics to a candidate prompt sentence, used to evaluate its quality or suitability.

The term “answer sentence” refers to a natural language output generated by the generative information processing model in response to a prompt sentence, describing information or recommended actions relating to a disaster situation.

The term “post-processing” refers to a processing step applied to a generated answer sentence, including at least one of filtering, editing, formatting, and validation against safety rules.

The term “safety rule” refers to a predetermined condition or constraint used to prevent the inclusion of harmful, misleading, or inappropriate content in a generated answer sentence.

The term “formatting rule” refers to a predetermined condition or specification that controls the presentation style of a generated answer sentence, including at least one of list formatting, paragraph structure, and labeling.

The term “response information” refers to data transmitted from the server to the terminal, including at least the post-processed answer sentence and optionally additional metadata.

The term “visual output device” refers to a device, such as a display, configured to present visual information to the user.

The term “audio output device” refers to a device, such as a speaker or headphone, configured to present audio information to the user.

The term “emotion recognition processing unit” refers to a functional component, implemented by software executed by the processor and optionally by dedicated hardware, configured to estimate an emotional state of the user based on at least one of text content, usage behavior, and sensor data.

The term “emotional state” refers to an estimated psychological condition of the user, including at least one of calmness, anxiety, fear, confusion, and urgency.

The term “expression content” refers to the choice of wording, tone, and level of politeness used in a prompt sentence or an answer sentence.

The term “detail level” refers to a degree of granularity or specificity of the information included in a prompt sentence or an answer sentence, including at least one of a high-level summary and a step-by-step detailed explanation.

The term “external information source” refers to a data provider accessible over a communication network, including at least one of a public database, a meteorological data service, and an information distribution service operated by a public organization.

The term “statistical processing algorithm” refers to a computational procedure that analyzes numerical or categorical data using statistical techniques such as aggregation, distribution analysis, trend detection, and correlation analysis.

The term “machine learning algorithm” refers to a computational method that adjusts parameters of a model based on training data so as to perform tasks such as classification, regression, clustering, or prediction.

The term “predicted disaster scenario” refers to a hypothetical or expected disaster situation derived from analysis of disaster history information, weather history information, and other data.

The term “assumed question” refers to a hypothetical user question that has not yet been input in real time, but that is inferred or anticipated based on predicted disaster scenarios or historical usage patterns.

The term “candidate answer sentence” refers to an answer sentence generated in advance, prior to receiving an actual user question, for reuse or completion in response to a later real-time inquiry.

The term “real-time inquiry” refers to an inquiry information instance that is processed by the server in temporal proximity to its reception from the terminal, without substantial delay.

The term “reuse” refers to an operation in which a previously generated prompt sentence or answer sentence is applied, wholly or partly, in responding to a new user inquiry.

The term “supplementary information” refers to additional data, including pre-generated prompt sentences and candidate answer sentences, used to complement or refine an answer generated in response to a real-time inquiry.

In one embodiment, a server executes a disaster information support system implemented as one or more software modules running on general-purpose server hardware. The server uses at least one central processing unit and, in some embodiments, at least one graphics processing unit. The server runs an operating system such as a UNIX-like operating system and uses middleware such as a web server, an application framework, and a database management system. The server communicates with at least one terminal operated by a user over a wired or wireless communication network using a communication protocol such as HTTP or HTTPS.

The server executes an application program implemented, for example, in a high-level programming language using a web application framework such as a Python-based framework or a Java-based framework. The server uses a web server component such as a generic HTTP server to receive requests from the terminal and to transmit responses to the terminal. The server uses a database management system such as a relational database or a document-oriented database to store disaster history information, weather history information, countermeasure guideline information, guideline information provided from public organizations, pre-generated prompt sentences, and pre-generated answer sentences. The server receives, from the terminal, inquiry information including a natural language question expressed as text. The server stores the received text in memory as a character sequence encoded, for example, in a UTF-8 encoding. The server performs normalization on the character sequence. The server converts full-width characters to half-width characters if necessary, unifies line breaks and whitespace, standardizes punctuation, and converts the text to a canonical representation. The server uses text processing libraries to perform such normalization in a deterministic manner. By normalizing the text, the server reduces variability in the input representation and improves the stability of downstream natural language processing.

The server analyzes the normalized text using a natural language processing algorithm and a language representation model. In one embodiment, the server uses a tokenizer associated with a generative AI model such as a transformer-based language model. The server maps the normalized text into a sequence of token identifiers. The server feeds the token identifiers into a neural network model such as a bidirectional transformer encoder (for example, an encoder of the BERT type) that has multiple self-attention layers and feedforward layers. The server executes this model using a machine learning framework such as PyTorch or TensorFlow, optionally accelerated by a GPU.

The server obtains, from the output of the neural network, a vector representation for each token and a pooled representation for the entire sequence. The server applies one or more classifier layers, such as a linear layer followed by a softmax function, to the pooled representation to classify the disaster type, the temporal situation, the requested information type, and other intent categories. The server further applies sequence tagging layers, such as a conditional random field or a token-wise classifier, to the per-token vectors to detect entities associated with location and protection target. The server aggregates these outputs into structured intent information represented, for example, as a key-value map stored in memory. This structured representation enables the server to perform targeted database queries instead of unstructured keyword search, thereby reducing query cost and improving retrieval relevance.

The server accesses the storage apparatus containing disaster history information, weather history information, countermeasure guideline information, and guideline information from public organizations. The server executes parameterized queries against a relational database or a document-oriented store, using the structured intent information as query parameters. For example, the server uses the disaster type, location, and temporal situation to restrict a query to records whose disaster type field matches the predicted disaster type, whose region field matches or is hierarchically related to the location, and whose time field is within a certain window of the temporal situation. The server further filters by data source and update time to prefer recent, authoritative records.

The server combines the retrieved records into structured factual data. The server groups records by category, such as “disaster summary,” “risk factors,” and “recommended countermeasures.” The server stores these groupings in a predetermined data structure, such as a nested list or dictionary, and sorts entries within each group based on relevance scores derived from time-series relevance, regional relevance, and reliability. The server discards records whose reliability score falls below a threshold. By constructing this structured factual data before invoking a generative AI model, the server reduces the amount of text that must be processed by the generative model and ensures that the model receives a curated subset of high-value information, which improves both computational efficiency and output quality.

The server constructs a prompt sentence for a generative AI model, which may be a transformer-based autoregressive language model deployed on the same server or on a separate inference server. The server assembles the prompt sentence by concatenating multiple segments in a predetermined order. The server inserts role designation information, such as “You are a disaster prevention advisor.” The server inserts output constraint information, such as “Provide concise, concrete actions suitable for a non-expert user, and use numbered steps.” The server summarizes the disaster situation using the structured factual data, and inserts disaster summary information and risk factor information as factual context. The server selects recommended countermeasure information and inserts it in a form that the generative model can elaborate upon, such as bullets or short factual statements.

The server then appends the user's natural language question as a user instruction. For example, the server constructs a prompt sentence such as:

“You are a disaster prevention advisor. Use the following factual data from the disaster database and provide step-by-step guidance suitable for a non-expert user.

Factual data: The disaster type is an earthquake. Occurrence time: night. Building type: wooden residential house. Government guideline: secure an escape route by opening doors; protect the head with a cushion or pillow; stay away from furniture that may fall.

User question: What are the appropriate measures when an earthquake occurs at night in a wooden house?

Please provide concrete, numbered safety measures.”

In another example, the server constructs a prompt sentence such as:
“You are an expert disaster prevention advisor. Use the following factual data from authoritative sources and respond in simple language.

Factual data: The disaster type is a typhoon. Expected arrival: tomorrow. Region: user's city.

Government guideline: close and lock windows and shutters; prepare an emergency bag; check evacuation shelters; avoid rivers and coastal areas.

User question: Please tell me the safety measures I should take when a large typhoon is expected to hit my city tomorrow.

Please output a numbered list of recommended actions.”

The server generates multiple candidate prompt sentences by varying the arrangement, level of detail, and explicitness of constraints. The server evaluates the candidate prompt sentences using at least two mechanisms. First, the server uses a lightweight evaluation model, such as a smaller transformer-based model, that outputs a predictive score of expected answer quality. The server feeds each candidate prompt into this evaluation model to obtain a numerical score. Second, the server applies rule-based evaluation criteria, such as checking whether required fields (disaster type, location, instructions to be concrete and safe) are present, whether the prompt length remains below a predetermined token count to control inference cost, and whether duplicate or irrelevant sentences are absent. The server combines the model-based score and the rule-based score, for example by a weighted sum, and selects the candidate prompt sentence with the highest combined score. By performing this prompt optimization step, the server improves the effectiveness of the generative AI model for a given computational budget and reduces the number of regeneration cycles required to obtain an acceptable answer, thereby improving processing speed and resource utilization.

The server supplies the selected prompt sentence to a generative AI model. In one embodiment, the generative AI model is a transformer decoder network having multiple layers of masked self-attention and feedforward sublayers, trained on large-scale text data.

The server uses a tokenizer associated with the model to convert the prompt sentence into a sequence of token identifiers. The server allocates model parameters (weights and biases) in memory and performs a forward pass through the network, computing attention scores, intermediate activations, and output logits. The server uses a decoding algorithm, such as beam search or nucleus sampling, to generate an answer sentence token by token. The server constrains the decoding process by applying temperature scaling and maximum length limits, in order to control the diversity and length of the generated answer.

The server monitors the logits associated with potentially unsafe content and, if necessary, masks or reduces the probability of tokens corresponding to undesired categories. The server obtains the sequence of generated tokens, decodes them back into text, and forms the answer sentence. The server then applies post-processing. The server enforces safety rules, such as removal of statements that contradict authoritative guidelines or that instruct the user to perform hazardous actions. The server enforces formatting rules, such as inserting line breaks and numbering to create a list structure. The server may split the answer into sections (e.g., “Before the disaster,” “During the disaster,” “After the disaster”) in accordance with predetermined templates.

The server transmits the post-processed answer sentence to the terminal via the communication interface. The terminal receives the response and displays it using a graphical user interface. The terminal may use a software library to render the text in an easily readable layout, using font size adjustments and automatic line wrapping. The terminal may also use a text-to-speech engine running on the terminal's processor to convert the answer sentence into audio. The terminal outputs the audio via an audio output device, such as a speaker or headphones. By presenting the answer both visually and audibly, the system increases accessibility and utility during disaster situations where visual attention may be limited.

The server estimates the emotional state of the user using an emotion recognition processing unit. The server analyzes textual features of the user's input, such as sentiment indicators, intensity words, and repeated questions, using a classifier model trained on annotated emotional data. The server optionally uses behavioral features, such as input speed or frequency of inquiries, to refine the estimation. The server represents the emotional state as one of several categories, such as calm, anxious, or panicked. The server adjusts the expression content and the detail level of the prompt sentence or the answer sentence based on the emotional state. For example, when the server detects high anxiety, the server directs the generative model to produce shorter, highly concrete steps and avoids technical jargon.

When the server detects a calm state and a request for detail, the server instructs the model to explain rationales behind each step. This adaptive behavior reduces user confusion, decreases the likelihood of repeated clarification requests, and consequently reduces communication and computation load.

The server performs offline or background processing to improve real-time performance. The server periodically collects disaster history information, weather history information, and countermeasure guideline information from external information sources. The server stores raw data in the storage apparatus and applies statistical processing algorithms, such as time-series analysis and clustering, to identify patterns and likely disaster scenarios by region and season. The server uses machine learning algorithms, such as supervised learning and unsupervised learning, to predict potential future disaster scenarios and to infer assumed questions that users may ask in those scenarios.

The server generates prompt sentences and candidate answer sentences for these predicted scenarios in advance. For example, the server generates a prompt sentence for a predicted heavy rainfall event in a specific region and obtains a corresponding answer sentence from the generative AI model during a low-load period. The server stores these pre-generated prompts and answers in the storage apparatus, indexed by disaster type, region, and scenario parameters. During an actual disaster, the server retrieves the pre-generated prompt and answer that best matches the structured intent information and either reuses the answer directly or uses it as supplementary information when constructing a new prompt. This caching of pre-computed outputs reduces the real-time computational burden on the generative model and shortens response time, thereby improving scalability during periods of heavy access.

The server uses specific data structures and processing flows to achieve these improvements.

The server maintains an intent information object that holds fields for disaster type, temporal situation, location, protection target, and requested information type. The server maintains a factual data object that groups retrieved records into categories and stores relevance scores.

The server uses these objects to drive deterministic steps in prompt construction, rather than relying on ad hoc string concatenation. This structured architecture allows the server to systematically control prompt length, content coverage, and constraint specification. The technical effect is a reduction of token count passed to the generative model while preserving or improving informativeness, which directly reduces inference time and memory usage.

The server implements model training and updating processes for the language representation model and the emotion recognition model. The server stores training data consisting of input texts, labels (for intent categories, entities, and emotional states), and optional auxiliary features. The server defines a loss function, such as cross-entropy loss, that measures the discrepancy between model predictions and labels. The server uses an optimization algorithm, such as stochastic gradient descent with adaptive learning rate, to update model parameters. The server may use data augmentation techniques, such as synonym replacement or paraphrasing, to increase training data diversity. By iteratively minimizing the loss function on training data, the server improves the accuracy of intent recognition and emotion recognition, resulting in more precise data retrieval and better adaptation of response style.

The server further employs a non-conventional combination of deterministic rules and learned models to improve technical performance. For example, the server uses rule-based filters to guarantee that certain mandatory items (such as evacuation routes or emergency contact methods) are always considered when relevant, regardless of model output. The server uses a model-based system to rank and select among many possible relevant items.

This hybrid approach enables the system to meet safety-critical requirements without sacrificing the flexibility and context-awareness of a generative model. Such a design differs from simple automation of human decision-making by formally encoding structural constraints and combining them with learned ranking functions in a manner optimized for machine execution.

The terminal and the server cooperate to achieve end-to-end technical effects. The terminal reduces network load by compressing request payloads and encoding them efficiently. The server compresses responses where appropriate and uses pagination or segmentation when answers become long, which helps prevent timeouts and retransmissions at the transport layer. The server aggregates and caches frequently requested factual data and pre-generated answers so that multiple user requests can be served without duplicative computation. These mechanisms collectively reduce network traffic, improve response latency, and enhance reliability under conditions of limited bandwidth or high demand.

The described configuration and processing provide improvements to computer technology rather than solely automating human reasoning. The server converts unstructured natural language questions into structured intent information, applies optimized data retrieval and prompt construction mechanisms, selects prompt sentences based on model-based and rule-based evaluation indices, and generates responses with controlled safety and format. The server employs specialized data structures, network protocols, neural network architectures, and hybrid decision logic that are tailored for disaster-specific information processing. As a result, the system decreases computational overhead per query, increases accuracy of retrieved information, reduces token-level redundancy processed by the generative model, and minimizes repeated user interactions needed to clarify ambiguous responses. These technical effects are realized within the computing infrastructure itself and are not merely incidental to a business or administrative process.

In alternative embodiments, the server may use different types of generative AI models, such as sequence-to-sequence models with an encoder-decoder structure, or models trained specifically on disaster-related corpora. The server may partition model components across multiple physical machines, using a distributed inference framework. The server may replace or augment the transformer-based language representation model with convolutional or recurrent networks in environments with constrained resources. The server may also adapt the architecture of the emotion recognition processing unit to use multimodal features obtained from the terminal, such as sensor readings or interaction logs, to further refine emotional state estimation. These variations preserve the core concept of structured intent extraction, optimized prompt construction, and model-guided answer generation with safety and formatting controls, while allowing adaptation to diverse hardware and software environments.

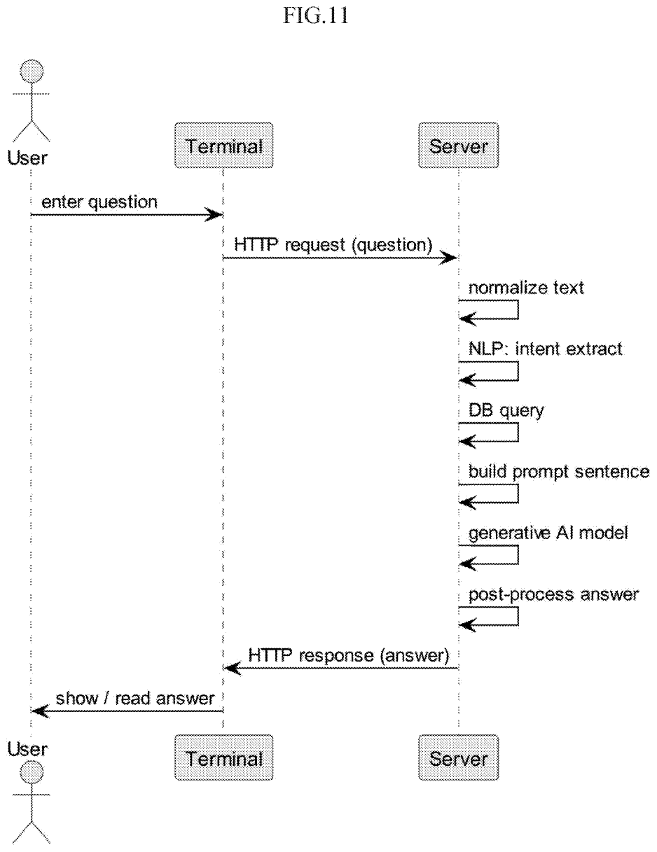

The following describes the processing flow using FIG. 11.

### Step 1:

User operates the terminal to input a natural language question.

User provides the input as text via a touchscreen keyboard or as speech via a microphone.

Terminal, in the case of voice input, converts the audio signal into text data using a speech recognition engine and stores the resulting character string in a local buffer.

Terminal sets this text as the “question” field of an HTTP request body, adds metadata such as a terminal identifier and timestamp, and outputs a structured request object ready for network transmission.

### Step 2:

Terminal sends the structured request object to the server via a communication interface.

Terminal uses a communication protocol such as HTTPS to encapsulate the HTTP request and transmits the request over a wireless or wired network.

Terminal, as output of this step, delivers the HTTP request stream containing the encoded question text and metadata to the server's network endpoint.

### Step 3:

Server receives the HTTP request through a web server component and parses the incoming data.

Server extracts the request body, decodes it from a transfer encoding (for example, JSON format) into internal data structures, and retrieves the question text and metadata fields.

Server verifies the request method, content type, and presence of the required “question” field; if validation succeeds, the server outputs normalized request data consisting of raw question text and associated metadata for further processing.

### Step 4:

Server normalizes the question text to reduce variability in downstream processing.

Server takes the raw character sequence as input, and performs operations such as converting full-width characters to half-width characters, lowercasing where appropriate, unifying whitespace, and standardizing punctuation.

Server uses text-processing libraries to apply deterministic transformation rules to each character and token.

Server outputs a canonicalized text string that serves as a consistent input for natural language processing algorithms.

### Step 5:

Server tokenizes the normalized text and generates initial language representations.

Server supplies the canonicalized text string to a tokenizer associated with the generative AI model and a language representation model.

Server converts the text into a sequence of token identifiers and corresponding attention masks, performing data operations that map character spans to discrete token indices.

Server outputs a tokenized representation, including token IDs and positional indices, which is then used as input to neural network models for intent extraction.

### Step 6:

Server performs intent classification and entity extraction using a language representation model.

Server feeds the tokenized representation into a pre-trained encoder model, such as a transformer encoder implemented on CPU or GPU hardware, and computes hidden vector representations for each token and a pooled representation for the entire sequence.

Server applies classifier layers to the pooled vector to derive probability distributions over disaster type, temporal situation, and requested information type, and applies sequence tagging layers to the token vectors to detect entities such as location and protection target.

Server selects the most probable labels based on these distributions and assembles structured intent information as output, represented as key-value pairs (for example, disaster_type=earthquake, temporal_situation=night, location=user_city).

### Step 7:

Server constructs query parameters for accessing disaster-related data.

Server takes the structured intent information as input and maps each field to corresponding database schema attributes, such as disaster_type column, region column, and time_window field.

Server generates parameterized database queries (for example, SQL statements) where the values are bound to the recognized disaster type, region, and time constraints.

Server outputs one or more query objects that encapsulate the database command and parameter values to be sent to the storage subsystem.

### Step 8:

Server retrieves relevant records from the storage apparatus and aggregates them into structured factual data.

Server sends the query objects to a database engine, which returns result sets containing disaster history records, weather history records, countermeasure guideline records, and public-organization guideline records.

Server computes relevance scores for each record based on criteria such as time proximity to the temporal situation, spatial proximity to the user location, and reliability based on data source and update time.

Server filters out low-relevance records, groups the remaining records into categories (for example, disaster_summary, risk_factors, recommended_countermeasures), and outputs a structured factual data object containing categorized and ranked records.

### Step 9:

Server builds multiple candidate prompt sentences for a generative AI model.

Server takes the structured factual data and the original question text as input and assembles prompt candidates by applying different templates and varying elements such as role designation, level of detail, and explicitness of instructions.

Server performs string concatenation and template filling operations to include role designation information, output constraint information, disaster summary information, risk factor information, recommended countermeasure information, and the user question in each candidate.

Server outputs a list of candidate prompt sentences, each represented as a text string ready to be evaluated.

### Step 10:

Server evaluates the candidate prompt sentences and selects an optimal one.

Server inputs each candidate prompt sentence into an evaluation pipeline consisting of a lightweight evaluation model and a rule-based checker.

Server uses the evaluation model to compute a predictive score for expected answer quality, performing a forward pass over tokenized versions of each candidate.

Server applies rule-based checks to verify presence of mandatory elements, enforce maximum length thresholds, and detect redundant or irrelevant portions.

Server combines the predictive score and rule-based score, for example by weighted summation, for each candidate, and selects the candidate with the highest combined score.

Server outputs the selected prompt sentence as a single optimized text string.

### Step 11:

Server performs generative inference using the selected prompt sentence and a generative AI model.

Server tokenizes the selected prompt sentence and feeds the token sequence into an autoregressive transformer-based generative AI model running on a computation apparatus.

Server executes successive forward passes through the model, at each time step computing output logits, applying decoding strategies such as beam search or nucleus sampling, and selecting the next token according to probability distributions and decoding constraints.

Server continues token generation until a stop condition is met, such as reaching an end-of-sequence token or a maximum length, and then decodes the generated token sequence into a natural language answer sentence.

Server outputs the raw generated answer text for downstream post-processing.

### Step 12:

Server post-processes the generated answer and ensures safety and formatting requirements.

Server takes the raw generated answer text as input and runs it through a safety filter that checks for prohibited content, contradictions with stored authoritative guidelines, and instructions that may increase user risk.

Server edits, masks, or regenerates parts of the answer if unsafe patterns are detected.

Server applies formatting rules to convert the text into a structured form such as a numbered list, inserting line breaks and section headings where necessary to improve readability.

Server outputs a post-processed answer sentence that satisfies predefined safety and formatting constraints.

### Step 13:

Server adjusts the answer content and detail level based on the user's emotional state.

Server inputs previous user messages, current question text, and optionally interaction patterns into an emotion recognition processing unit that uses a classifier model to estimate emotional categories such as calm, anxious, or panicked.

Server modifies the post-processed answer by either simplifying the language, shortening the explanation, or providing additional detail and rationale according to the estimated emotional state.

Server may also update prompt construction parameters for subsequent interactions, storing an emotional-state indicator associated with the user session.

Server outputs a final answer text adapted to both factual needs and emotional context.

### Step 14:

Server generates a response message and transmits it to the terminal.

Server encapsulates the final answer text, along with auxiliary metadata such as disaster type and timestamp, into a response object encoded in a structured format.

Server constructs an HTTP response with an appropriate status code and content type and writes the encoded response object into the response body.

Server sends the HTTP response via the communication interface to the terminal over the network.

Server outputs the response as a network data stream received by the terminal.

### Step 15:

Terminal receives the response and presents the answer to the user.

Terminal accepts the HTTP response, parses the response body to extract the final answer text and any associated metadata, and stores the extracted data temporarily in local memory.

Terminal renders the answer text on a display, using a user interface layer to format numbered lists, headings, and line breaks in a legible manner.

Terminal, if a voice output option is enabled, passes the answer text to a text-to-speech engine, which generates an audio waveform that is output through a speaker or headphones.

Terminal outputs the visual and/or audio presentation as the final user-facing result, enabling the user to perceive and act on the recommended disaster countermeasures.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional disaster information systems typically provide static or coarse-grained notifications that are not sufficiently tailored to an individual user's current position, surrounding conditions, or situational understanding. In many implementations, a server merely pushes generic alerts or map overlays to user terminals, while leaving it to the user to interpret complex hazard information, identify appropriate evacuation destinations, and determine safe routes in real time. This places a heavy cognitive burden on the user and can lead to delayed or inappropriate responses during rapidly evolving disaster situations.

Further, known question-and-answer systems that employ natural language processing or generative AI models often operate independently from geospatial route computation and time-varying disaster data. Such systems may generate linguistically fluent responses but are not technically integrated with up-to-date geographic risk information, evacuation infrastructure information, or user-specific location context. As a result, they cannot reliably provide concrete, actionable guidance such as specific evacuation routes or suitable shelters that reflect current hazard conditions.

In addition, many existing systems do not adapt their information presentation to the emotional state of the user. In high-stress disaster scenarios, users may be anxious, confused, or overwhelmed, and a fixed, one-size-fits-all format of explanations can be either too complex or too sparse. Conventional approaches lack a mechanism in the core computing architecture to estimate user emotional state from data provided by a terminal and to algorithmically adjust prompt generation and response formatting, thereby failing to optimize comprehensibility and usability of the delivered guidance.

From a computing technology standpoint, there is therefore a need for a technical solution that tightly integrates: (i) low-level acquisition and continual updating of disaster-related data keyed to a user's dynamic position and environment, (ii) natural language processing and construction of prompt sentences for a generative AI model based on analyzed inquiry content and contextual data, (iii) geospatial route and shelter computation using disaster-aware algorithms, and (iv) emotion-aware adaptation of both prompt generation and response presentation. Such integration should be realized as specific configurations and coordinated operations of a processor and associated memory, rather than as a mere abstract idea or human mental process, so as to improve the functioning of the computer system itself in generating, structuring, and delivering disaster guidance.

The specific processing by the specific processing unit 290 of the data processing device 12 in Application Example 1 is realized by the following means.

The present invention provides a server comprising a processor and a storage medium, wherein the processor is configured to obtain position information and environmental information from a user terminal, acquire disaster-related information from the storage medium based on the position information and the environmental information, and update and provide the disaster-related information in accordance with temporal changes; analyze a natural-language inquiry sentence received from the user terminal by executing a natural language processing algorithm including at least morphological analysis, part-of-speech tagging, and key term extraction to interpret contents of the inquiry sentence; construct a prompt sentence for input to a generative AI model based on extracted key terms, the position information, and the disaster-related information, transmit the prompt sentence to the generative AI model, and receive a response sentence generated by the generative AI model; calculate evacuation route information and evacuation site information by using the position information and the disaster-related information in combination with a geographic information processing algorithm and a route search algorithm; integrate the response sentence with the evacuation route information and the evacuation site information to generate display data as integrated information for transmission to the user terminal; and estimate an emotional state of a user based on emotional information obtained from the user terminal, and modify at least one of a representation format of the prompt sentence and a representation format of the integrated information in accordance with the emotional state. This enables a technically improved disaster guidance platform in which the server itself performs coordinated data acquisition, natural language analysis, generative AI prompt construction, geospatial computation, and emotion-aware formatting, thereby producing real-time, context-specific, and cognitively optimized evacuation information that enhances the effectiveness and efficiency of computer-based disaster response support.

The term “processor” refers to a hardware-based computing unit, including one or more central processing units or other arithmetic logic resources, that executes instructions to perform the operations described in the claims.

The term “storage medium” refers to any non-transitory computer-readable medium, such as a semiconductor memory, magnetic storage device, or optical storage device, that stores programs, disaster-related information, route information, and structured data used by the processor.

The term “user terminal” refers to an information processing apparatus operated by a user, such as a mobile communication device, portable computing device, or other client device, that transmits information to and receives information from the server.

The term “position information” refers to data indicating a geographic position of the user terminal, including at least a set of coordinates or other location identifiers obtained by a positioning function of the user terminal or an external service.

The term “environmental information” refers to data representing conditions surrounding the user terminal, including but not limited to weather conditions, hazard alerts, or sensor outputs, that are used to characterize a disaster-related situation.

The term “disaster-related information” refers to data indicating at least one of a disaster type, hazard level, affected area, available evacuation facilities, or infrastructure status, which is stored in the storage medium and updated over time.

The term “natural-language inquiry sentence” refers to a text sequence composed in a human language that expresses a user's question or request for information and is transmitted from the user terminal to the server.

The term “natural language processing algorithm” refers to a sequence of computational procedures executed by the processor to analyze natural-language text, including tokenization, syntactic or semantic analysis, and extraction of linguistic features.

The term “morphological analysis” refers to processing that segments a natural-language sentence into basic elements and determines grammatical attributes of the elements for subsequent linguistic analysis.

The term “part-of-speech tagging” refers to processing that assigns grammatical category labels, such as noun or verb, to tokens in a natural-language sentence.

The term “key term extraction” refers to processing that identifies specific words or phrases in a natural-language sentence that represent important concepts, entities, or actions relevant to interpretation of the sentence.

The term “prompt sentence” refers to a text string constructed by the processor that includes context information, analysis results, and instructions, and that is supplied as input to a generative AI model to control generation of an output.

The term “generative AI model” refers to an artificial intelligence model that generates natural-language text in response to an input prompt sentence by performing statistical or neural network-based inference.

The term “response sentence” refers to a natural-language text string output by the generative AI model in response to the prompt sentence and representing an answer or explanation for the user.

The term “geographic information processing algorithm” refers to a computational procedure that operates on geographical data such as coordinates, map features, or spatial attributes to derive information relating to locations or regions.

The term “route search algorithm” refers to a computational procedure that determines at least one path between two or more positions in a network representation of an area, based on criteria such as distance, time, or safety.

The term “evacuation route information” refers to data indicating at least one recommended path or set of instructions for movement from a current position to a safer area or evacuation site during a disaster.

The term “evacuation site information” refers to data indicating potential destinations for evacuation, including locations, identifiers, or attributes of facilities designated as shelters or safe areas.

The term “display data” refers to structured information formatted by the processor for presentation on a user terminal display, including text, graphical elements, or combined representations of routes and explanatory content.

The term “integrated information” refers to data obtained by combining the response sentence with evacuation route information and evacuation site information so that the combined data can be presented to the user in a unified manner.

The term “emotional information” refers to data derived from user interactions, biometric signals, or other user-related inputs that allow estimation of an emotional condition of the user.

The term “emotional state” refers to a condition of the user such as anxiety, calmness, confusion, or urgency, which is inferred from emotional information and used to adjust processing or presentation.

The term “representation format” refers to a manner of structuring, phrasing, or visually presenting information, including at least a choice of language style, level of detail, ordering of elements, or emphasis.

The term “structured data” refers to information organized in a predefined format, such as records, fields, or tables, that allows systematic storage, retrieval, and processing by the processor.

In one embodiment, a server cooperates with a user terminal operated by a user to provide disaster-related guidance that is dynamically adapted to the user's position, environmental conditions, inquiry content, and emotional state. The server includes at least one processor and at least one storage medium. The storage medium stores executable instructions, parameter sets, geographic data, disaster-related data, and model configuration data. The processor executes the instructions to realize the functional units described below.

The server uses general-purpose computing hardware, such as a multicore central processing unit and optionally one or more graphics processing units. The server executes an operating system, an application framework, and software components including at least a natural language processing library, a numerical computation library, and a deep learning framework.

In specific embodiments, the server uses a scripting language runtime, a machine learning framework comparable to a tensor-computation library, and a natural language processing toolkit comparable to an open-source NLP library. The server further accesses a relational database system and a map/geographic information system.

The terminal uses mobile computing hardware such as a portable communication device including a processor, a memory, a display, a touch input interface, a communication interface, and a positioning module. The terminal executes an operating system, a graphical user interface framework, and an application that communicates with the server through a network. The terminal uses a location service of the operating system to obtain position information from a positioning sensor, such as a satellite-based receiver or a network-based positioning mechanism. The terminal transmits the position information and a natural-language inquiry sentence to the server over a secure communication protocol.

The server stores disaster-related information in a structured form in the storage medium. The disaster-related information includes, for example, tables of past disaster cases, hazard levels keyed by geographic grid cells, records of road accessibility, evacuation site attributes, and time-stamped sensor or alert data. The server organizes this information using indexed relational tables and, in some embodiments, additional key-value or columnar data structures for high-throughput access. The server associates each disaster record with a geographic region identifier and a time interval so that the processor can efficiently query disaster conditions relevant to the current position information and time.

The server uses a natural language processing module to analyze the natural-language inquiry sentence transmitted from the terminal. The server converts the inquiry sentence into internal data structures representing tokens, part-of-speech tags, dependency relations, and semantic labels. In one embodiment, the server uses word tokenization, subword segmentation, part-of-speech tagging, and named entity recognition. The server stores the analysis results in an in-memory structure such as a list of token objects and a feature vector representation.

The server generates a feature vector from the natural-language inquiry sentence by combining token embeddings, position encodings, and contextual embeddings computed by a deep neural network encoder. The server then derives key terms and intent labels from the feature vector using a trained classification layer. The key terms may indicate, for example, a disaster type (“earthquake”, “flood”), a requested action (“evacuate”, “prepare”), or a requested information type (“shelter”, “route”). The server uses these key terms as part of the basis for constructing a prompt sentence for a generative AI model.

The server employs a generative AI model realized as a parameterized neural network, for example a sequence-to-sequence architecture or a transformer-based language model. The generative AI model is stored as a collection of numeric parameters (weights and biases) and a network topology definition. The server loads the parameters into memory and performs inference by executing matrix multiplications, non-linear activation functions, normalization operations, and attention calculations on the processor and optionally the graphics processing unit. In one embodiment, the generative AI model includes multiple layers of self-attention, feed-forward sublayers, and normalization layers, with parameters learned from a corpus of text that includes disaster-related documents and general language use.

The server constructs a prompt sentence that conditions the generative AI model on both the user's inquiry and the relevant contextual data retrieved from the storage medium. The prompt sentence typically includes: (i) a description of the user's current position in human-readable form, (ii) a summary of current disaster-related information in the vicinity, (iii) the user's original question, and (iv) explicit instructions regarding the desired output language, level of detail, and safety focus. The server may generate, for example, a prompt sentence of the following form:

“User's current location is near the central district of a large city (latitude 35.6938, longitude 139.7034). The user asked the following question: ‘Where should I evacuate if an earthquake happens?’ An earthquake risk is currently high in this area. Based on best practices for earthquakes in urban environments, provide specific evacuation route types, safe shelter characteristics, and concrete safety actions in Japanese. Give clear, step-by-step instructions for residents.”

In another example, the server may generate a prompt sentence for flood guidance: “User's current location is a low-lying residential area near a river (latitude 35.7100, longitude 139.8107). The user asked: ‘If a flood happens, what should I do and where should I go?’ Based on past flood cases in urban areas and general disaster prevention guidelines, explain in Japanese where the user should evacuate (for example, high-ground shelters or upper floors of reinforced buildings) and what specific countermeasures the user should take. Provide step-by-step, practical instructions suitable for residents, and avoid giving medical or legal advice.”

The server inputs the prompt sentence to the generative AI model by encoding the text as a sequence of tokens and running the model forward. The server obtains a sequence of output tokens representing a response sentence. The server then converts the tokens back to natural-language text. The response sentence contains explanatory content, safety recommendations, and general behavioral guidelines. The server optionally constrains the decoding process using beam search with predefined parameters, such as beam width and maximum length, to control fluency and verbosity.

The server stores geographic data including road segments, intersections, elevation information, and designated evacuation sites. The server represents this data as graph structures, such as a directed graph where nodes correspond to intersections or locations and edges correspond to road segments with associated weights. The server stores edge weights that reflect travel time, distance, and disaster-specific risk. For example, the server increases the weight of edges that pass through flood-prone areas during a flood event or through narrow streets in an earthquake-prone region.

The server uses a route search algorithm such as Dijkstra's algorithm or an A* search algorithm to compute evacuation route information. The server initializes a priority queue with the node corresponding to the user's current position and iteratively expands nodes based on the cumulative cost, which is a function of distance, estimated travel time, and disaster risk weights. The server determines one or more paths from the current position node to nodes corresponding to evacuation sites. The server outputs the route as a sequence of nodes and edges, and calculates attributes such as total length and estimated time. By integrating dynamic disaster risk into the edge weights, the server changes the internal behavior of the route search algorithm, resulting in routes that avoid historically or currently dangerous areas. This contrasts with a conventional navigation system that optimizes only for distance or time.

The server uses a geographic information processing algorithm to map the graph-based route to a polyline representation suitable for display. The server samples intermediate points along each edge, converts them into geographic coordinates, and packages the coordinates into display data. The server also associates textual instructions with the route, such as “Walk north for 200 meters, then turn right at the main intersection and proceed to the community center.”

The server integrates the response sentence from the generative AI model with the evacuation route information and the evacuation site information to generate integrated information. The server creates a data structure that includes the generated text, a list of route steps, a list of evacuation site descriptions, and risk warnings. The server then transforms this integrated information into display data formatted for the terminal. The terminal renders the display data using its graphical user interface framework, presenting both the text explanation and the map-based route on the display.

The server estimates an emotional state of the user based on emotional information obtained from the terminal. The emotional information may include, for example, prosodic features extracted from voice input, typing speed deviations, selection behavior within the application, or explicit user feedback. The server converts such signals into numerical features and inputs them to an emotion classification model realized as a neural network or another statistical classifier. The model outputs scores corresponding to emotional categories such as anxiety, calmness, or confusion. The server uses these scores to select a representation format of the prompt sentence and the integrated information. For example, if the user is classified as highly anxious, the server simplifies sentence structure, reduces technical terms, and emphasizes key actions; if the user is calm and experienced, the server provides more detailed explanations and background reasoning.

The server thereby implements a feedback mechanism in which the emotional state affects both the input to the generative AI model (through the prompt sentence) and the output presentation (through formatting rules). This mechanism alters how the server uses computational resources: the server selects different prompt templates, adjusts the length and granularity of the response, and may re-run the generative AI model with different decoding parameters. As a result, the server improves comprehension and reduces the likelihood that the user misinterprets critical safety guidance, which in turn reduces repeated queries and network traffic.

The server trains the generative AI model and auxiliary models using stored training data before deployment. The server, or a separate training system, executes a learning phase in which the model parameters are updated to minimize a loss function that measures the difference between predicted outputs and target outputs. The server uses a loss function such as cross-entropy for language generation and classification tasks. The server updates the parameters using an optimization algorithm such as stochastic gradient descent with momentum or adaptive learning rate variants. The server may apply techniques such as data augmentation, regularization, and early stopping to improve generalization. The server also fine-tunes the generative AI model on a domain-specific corpus of disaster-related texts so that the model learns patterns and terminology specific to disaster situations. This training process produces a model that behaves differently from a generic language model and that is optimized to cooperate with the particular data structures and algorithms of the server.

The server improves computer technology in several ways. First, the server reduces overall computation and network load by constructing prompt sentences that selectively encode only relevant disaster information and user context, rather than transmitting full raw data sets to the generative AI model. This targeted prompt construction reduces the number of tokens processed by the model and shortens inference time. Second, the server improves accuracy and reliability by embedding dynamically updated risk weights into the route search algorithm and feeding the resulting route structure back into the prompt, enabling the generative AI model to generate explanations that are consistent with the computed route.

Third, the server enhances data management by organizing disaster records, route graphs, and emotional states in coordinated, indexed structures that allow low-latency queries tailored to the current user context.

The server applies non-conventional processing sequences that differ from human mental operations. Rather than simply answering a question or showing a static map, the server first analyzes linguistic content to extract key terms, then uses these key terms to filter and transform large volumes of disaster data into compact context descriptors, then uses graph-based algorithms to compute risk-aware routes, and finally fuses these results into a structured prompt sentence controlling a generative AI model. This multi-stage transformation uses internal representations and control parameters that a human cannot practically process in real time, and that are specifically designed to exploit the computational capabilities of the hardware and software stack.

The server can be configured in alternative embodiments. In one embodiment, the server hosts the generative AI model locally and executes all inference on dedicated acceleration hardware, thereby minimizing latency and avoiding dependence on external services. In another embodiment, the server acts as an intermediary between the terminal and an external model service, but still performs prompt sentence construction, contextual filtering, and post-processing. In yet another embodiment, the server adapts the neural network architecture of the generative AI model, for example by using fewer layers or a reduced hidden dimension, for deployment on constrained hardware while preserving the overall functional flow.

The terminal may also be configured in various ways. In one embodiment, the terminal displays the evacuation route on a map and overlays textual instructions on the map near the corresponding road segments. In another embodiment, the terminal converts the integrated information into speech and provides audio guidance. The terminal may further collect additional signals such as accelerometer readings or barometric pressure to provide richer environmental information to the server.

The user operates the terminal by entering natural-language questions, optionally speaking them into a microphone, and following the displayed or spoken guidance. The user may provide explicit feedback indicating whether the instructions were useful or confusing. The server can store this feedback and use it to retrain or adjust model parameters, which in turn refines the behavior of the generative AI model and the emotion classification model over time.

Through these configurations, the server, the terminal, and the user cooperate in a technical system that combines natural language processing, generative modeling, graph-based routing, dynamic data retrieval, and emotion-aware formatting. The server performs specialized computational operations that transform diverse input signals into integrated, real-time, and context-specific disaster guidance, thereby improving the functioning of the underlying computing system and achieving technical effects such as improved processing efficiency, improved accuracy of evacuation guidance, and improved robustness of user interaction under stressful conditions.

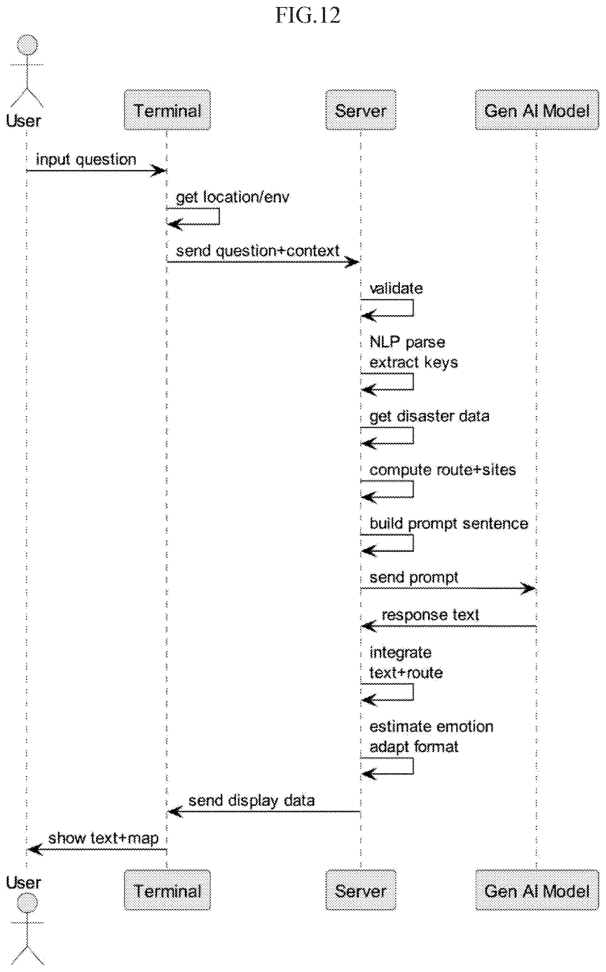

The following describes the processing flow using FIG. 12.

### Step 1:

The user operates the terminal to input a natural-language inquiry.

The user opens an application on the terminal and types or speaks a question such as “Where should I evacuate if an earthquake happens?” or “If a flood occurs here, what should I do and where should I go?”.

Input: User's natural-language inquiry.

The terminal converts the user's input into a text string (for speech, the terminal uses a speech recognition module to generate text) and displays it for confirmation.

Output: Natural-language inquiry text prepared for transmission.

### Step 2:

The terminal acquires position information and environmental information.

The terminal calls an operating-system location service to obtain latitude, longitude, accuracy, and timestamp, and may also obtain environmental signals such as current weather status or local alert flags from onboard sensors or external services.

Input: Requests to the OS location service and optional sensor/network queries.

The terminal receives raw location and environmental data, normalizes coordinate formats, and packages them into a structured internal object.

Output: Normalized position information and environmental information associated with the inquiry.

### Step 3:

The terminal transmits the inquiry and context to the server.

The terminal creates a request payload including at least the inquiry text, the position information, the environmental information, and a terminal identifier, and sends this payload to the server via a secure communication channel.

Input: Inquiry text, position information, environmental information.

The terminal serializes these data into a request (for example, a structured message) and performs encryption and header attachment.

Output: Network message containing the user's inquiry and context, delivered to the server.

### Step 4:

The server receives and validates the request.

The server accepts the network message, parses the payload, and extracts the inquiry text, the position information, and the environmental information. The server checks that required fields are present and values are within valid ranges.

Input: Serialized request from the terminal.

The server performs syntax checks and basic consistency checks (for example, coordinate range, text length) and logs the request metadata.

Output: Validated inquiry text, position information, and environmental information stored in server memory.

### Step 5:

The server retrieves disaster-related information relevant to the user's location.

The server queries a disaster information database using the position information and environmental information as keys or filters, and retrieves records for current and recent disasters, hazard levels, and available evacuation sites near the user.

Input: Position information, environmental information.

The server converts the position information into region identifiers (for example, grid cell IDs), performs database queries on indexed tables, and aggregates the results into a structured set of disaster-related records.

Output: Disaster-related information pertinent to the user's current context.

### Step 6:

The server performs natural language preprocessing of the inquiry.

The server passes the inquiry text to a natural language processing module that executes tokenization, morphological analysis, part-of-speech tagging, and key term extraction.

Input: Natural-language inquiry text.

The server segments the text into tokens, assigns part-of-speech tags, identifies candidate entities and verbs, and selects key terms that characterize the disaster type, requested action, and information focus.

Output: Analyzed linguistic structure and a set of extracted key terms.

### Step 7:

The server derives user intent and disaster category from the extracted key terms.

The server maps key terms to categories such as “earthquake”, “flood”, “evacuation”, “preparation”, or “shelter information”.

Input: Extracted key terms.

The server applies a rule-based mapping or a trained classifier that takes the key terms as features, computes scores for each category, and selects the most probable disaster type and intent.

Output: Derived disaster category and user intent label.

### Step 8:

The server constructs a context representation for route computation.

The server combines the position information, the environmental information, the disaster-related information, and the derived disaster category to generate a compact context structure for geographic processing.

Input: Position information, environmental information, disaster-related information, disaster category.

The server selects relevant hazard layers, updates risk weights on graph edges in the geographic dataset, and builds an in-memory data structure representing the current state of the road network and evacuation sites.

Output: Disaster-aware geographic context used for evacuation route calculation.

### Step 9:

The server calculates evacuation route information and evacuation site information.

The server runs a route search algorithm on the geographic context, using the user's position as a start node and candidate evacuation sites as goal nodes.

Input: Disaster-aware geographic context and evacuation site data.

The server computes path costs that combine distance, estimated travel time, and disaster risk scores, iteratively expands nodes in the graph, and selects one or more optimal paths that minimize a composite cost function.

Output: Evacuation route information (paths, steps, coordinates) and evacuation site information (site identifiers, locations, attributes).

### Step 10:

The server constructs a prompt sentence for the generative AI model.

The server prepares a text that merges the user's inquiry, the human-readable description of the user's location, the current disaster-related information, the derived disaster category, and high-level results of the route computation.

Input: Inquiry text, position information, disaster-related information, disaster category, high-level route and site summaries.

The server formats these elements into a single prompt sentence, specifying the required language, level of detail, and safety emphasis.

Output: Prompt sentence for conditioning the generative AI model.

### Step 11:

The server performs feature encoding of the prompt sentence.

The server converts the prompt sentence into token IDs and corresponding embeddings suitable for input into the generative AI model.

Input: Prompt sentence text.

The server applies a tokenizer to split the text into tokens, maps each token to an embedding vector using a pre-trained embedding matrix, and attaches positional encodings to form a sequence of input vectors.

Output: Encoded prompt representation to be fed into the generative AI model.

### Step 12:

The server executes the generative AI model to generate a response sentence.

The server inputs the encoded prompt representation to the generative AI model and performs forward propagation through the neural network to obtain an output token sequence.

Input: Encoded prompt representation.

The server computes attention scores, hidden layer activations, and output logits at each decoding step, applies a decoding strategy such as beam search or sampling, and selects the most appropriate token sequence.

Output: Generated token sequence representing the response sentence.

### Step 13:

The server decodes the generated token sequence into natural-language text.

The server converts the output tokens back into characters or words in the target language and post-processes the text.

Input: Generated token sequence.

The server maps token IDs to vocabulary entries, concatenates them, corrects spacing and punctuation, and optionally applies filters to remove disallowed content or adjust style.

Output: Natural-language response sentence suited for human reading.

### Step 14:

The server collects emotional information from the terminal and estimates the user's emotional state.

The server receives emotional-related signals, such as response time, error correction frequency, or any explicit emotion indicators sent by the terminal.

Input: Emotional-related signals from the terminal.

The server transforms these signals into numerical features and applies an emotion classification model (for example, a neural network classifier) to compute probabilities for emotional states like “anxious”, “calm”, or “confused”.

Output: Estimated emotional state of the user.

### Step 15:

The server adapts the representation format of the prompt sentence and integrated information based on the emotional state.

The server uses the estimated emotional state to choose formatting rules and, if necessary, to adjust the prompt template for future interactions.

Input: Estimated emotional state, current response sentence, evacuation route information, evacuation site information.

The server decides, for example, whether to shorten sentences, highlight key steps, or add reassurance phrases, and reformats the textual parts and ordering of elements in the integrated information.

Output: Emotion-adapted integrated information structure ready for display generation.

### Step 16:

The server generates display data integrating the response sentence and the route information.

The server combines the response sentence, the evacuation route information, the evacuation site information, and representation rules into a unified display specification.

Input: Emotion-adapted integrated information structure.

The server assigns map coordinates to route polylines, links textual instructions to route segments, and constructs a structured payload containing both narrative text and graphical route data.

Output: Display data formatted for rendering on the terminal.

### Step 17:

The server transmits the display data to the terminal.

The server encapsulates the display data in a response message and sends it to the terminal via the network.

Input: Display data.

The server serializes the structured payload, sets appropriate headers, and pushes the message to the terminal's network address.

Output: Network response containing integrated disaster guidance.

### Step 18:

The terminal renders the disaster guidance for the user.

The terminal receives the response, parses the display data, and updates the screen to show the generated text and map-based evacuation route.

Input: Network response from the server containing display data.

The terminal draws the route polyline on a map widget, places markers for evacuation sites, presents the response sentence and step-by-step instructions in text areas, and may trigger audio output for accessibility.

Output: Visual and/or audio presentation of evacuation guidance to the user.

### Step 19:

The user follows the presented guidance and optionally provides feedback.

The user observes the map and instructions on the terminal, moves along the indicated route toward the evacuation site, and may submit follow-up questions or feedback such as “This route is blocked” or “Please explain again more simply.”

Input: Displayed guidance, real-world observations by the user.

The user's actions result in new inquiries or signals that the terminal captures and sends back to the server, closing the loop for iterative refinement of guidance.

Output: Updated user input and contextual information for subsequent processing cycles.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional disaster information systems generally retrieve and display pre-defined warning messages or static summaries based on current sensor readings and simple rule-based thresholds. Such systems often rely on fixed message templates and manually designed decision trees, which limits their ability to adapt explanations or recommendations to changing data patterns, user context, or user mental state. As a result, these systems typically provide generic alerts that do not exploit the full breadth of available historical disaster data and meteorological data, and do not leverage predictive models to estimate future damage impact in a fine-grained manner.

In many architectures, disaster-related data and meteorological data are collected and stored in separate subsystems, and any analytic processing is executed in an offline batch fashion without tight integration with user-facing query handling. Machine learning models, if used at all, are often trained and invoked independently of the interactive user interface, so that the models cannot be dynamically combined with natural language questions and presented in a form that is directly meaningful to an end user. Consequently, there is a technical gap between the back-end data processing pipeline and the front-end information presentation layer.

Furthermore, existing conversational systems that use generative artificial intelligence models typically accept user questions and generate responses based solely on the textual content of the questions and the internal parameters of the language model. Such systems generally do not systematically construct prompt sentences that embed structured disaster-related data, statistical summaries, or outputs from trained prediction models. This lack of integration leads to responses that may be fluent but are poorly grounded in the most recent and relevant numerical data, and therefore may not be reliable for decision support in disaster scenarios. Additionally, known systems seldom consider user emotional state as a first-class input signal in the end-to-end information processing pipeline. Most systems output the same style and level of detail regardless of whether the user is anxious, confused, or experienced, which can impair comprehension and may increase cognitive load during emergencies. There is a need for a technical mechanism that automatically estimates a user's emotional state from interaction data and uses this estimate to adjust the formatting, wording, and emphasis of the generated responses in real time.

From a computer-technology standpoint, there is no unified mechanism that: (i) continuously acquires large-scale disaster-related data and meteorological data from heterogeneous public sources; (ii) normalizes and aggregates these data into structured training sets; (iii) trains and maintains a prediction model that estimates a numerical damage impact index; (iv) dynamically composes an extended prompt sentence that fuses the user's natural language question with up-to-date statistical information and prediction results; and (v) feeds this extended prompt sentence into a generative artificial intelligence model to produce context-aware, data-grounded responses whose presentation is further adapted based on an estimated emotional state of the user. The absence of such a mechanism results in underutilization of computing resources and of modern machine learning capabilities, and prevents disaster information systems from achieving higher accuracy, responsiveness, and user-specific optimization.

Accordingly, there is a need for an improved computer-implemented system and processing method that tightly integrates data acquisition, statistical processing, machine learning-based prediction, prompt construction, and generative artificial intelligence-based response generation, while also incorporating emotion recognition-based adjustment of the response, thereby enhancing the technical functionality, reliability, and usability of disaster information processing on a computing platform.

The specific processing by the specific processing unit 290 of the data processing device 12 in Example 2 is realized by the following means.

The present invention provides a server comprising a processor and a storage device, the processor being configured to automatically acquire disaster-related data and meteorological data from a plurality of publicly accessible information sources via a communication network, to store the acquired data as structured records in a data storage area of the storage device using data management software having a relational database management function, to load the structured records into data structure objects by means of statistical processing software, to perform aggregation processing and feature generation processing on the data structure objects to produce statistical information including indicators representing a degree of damage impact, an occurrence frequency, and a scale of loss for disasters, to generate and store a trained prediction model for predicting the degree of damage impact by applying a machine learning algorithm to a training data set derived from the aggregated and feature-rich data structure objects, to analyze a natural language prompt sentence input by a user by using a natural language processing engine so as to extract a question content, a target area, a target disaster type, and a target period, to generate an extended prompt sentence by combining the natural language prompt sentence with the statistical information and a prediction result of the degree of damage impact calculated by the trained prediction model, to input the extended prompt sentence to a generative artificial intelligence model and acquire from the generative artificial intelligence model a response sentence integrating an explanation based on past disaster records and a prediction regarding a future degree of damage impact, to perform emotion recognition processing that estimates an emotional state of the user from expression content, input text, and usage history information, to adjust an expression format or presentation content of the response sentence according to the estimated emotional state, and to convert the adjusted response sentence and the prediction result into a format viewable on a display device of a user terminal and provide the converted response sentence and prediction result to the user terminal. This enables the computing system to technically improve disaster information processing by unifying large-scale data acquisition, statistical aggregation, predictive modeling, and generative artificial intelligence-based natural language response generation into a single integrated pipeline that produces data-grounded, context-aware, and emotion-adaptive outputs, thereby enhancing the accuracy, responsiveness, and user-specific suitability of information provided during disaster-related interactions.

The term “processor” refers to a hardware processing unit, or a combination of hardware processing units, configured to execute instructions, perform arithmetic and logical operations, and control data flows within a computing system.

The term “storage device” refers to a hardware component, or a combination of hardware components, that persistently or semi-persistently stores digital data, including but not limited to magnetic storage, solid-state storage, and optical storage.

The term “communication network” refers to a wired or wireless data transmission infrastructure that enables electronic devices to exchange digital information, including but not limited to local area networks, wide area networks, and packet-switched networks.

The term “publicly accessible information sources” refers to network-accessible data-providing services that are made available by public organizations or other entities, and that can be accessed via the communication network using standardized interfaces without requiring proprietary client software.

The term “disaster-related data” refers to structured or unstructured digital information describing occurrences of natural or man-made disasters, including but not limited to disaster types, locations, times, magnitudes, casualties, and economic losses.

The term “meteorological data” refers to digital information describing atmospheric and environmental conditions, including but not limited to temperature, precipitation, wind, humidity, and related measurements over time and space.

The term “structured data” refers to digital information that is organized according to a predefined schema or data model, such as records with named fields, and that can be stored and queried using table-form or object-form representations.

The term “data storage area” refers to a logical region of the storage device that is assigned for storing and managing data sets used by the processor, including but not limited to database files and associated metadata.

The term “data management software” refers to a software component or set of software components configured to create, store, retrieve, update, and manage structured data sets in the storage device.

The term “relational database management function” refers to a capability of the data management software to store data in related tables, to enforce relational constraints, and to process structured query language operations.

The term “statistical processing software” refers to a software component or library that performs statistical calculations, aggregation, filtering, and transformation on digital data sets.

The term “data structure objects” refers to in-memory representations of data, such as arrays, tables, or records, that are used by the processor to manipulate and analyze the data.

The term “aggregation processing” refers to processing that groups data records according to one or more keys and computes summary values, such as totals, averages, maxima, or counts, for each group.

The term “feature generation processing” refers to processing that derives new data attributes, or features, from existing data attributes, including but not limited to normalization, combination, encoding, and transformation of values.

The term “statistical information” refers to information derived from numerical analysis of data, including but not limited to summary measures, distributions, and indices that characterize the underlying data.

The term “degree of damage impact” refers to a quantitative or qualitative index representing the severity or extent of damage associated with a disaster event or scenario, including human, economic, and environmental effects.

The term “occurrence frequency” refers to a statistical measure indicating how often a particular type of event occurs within a specified time period or region.

The term “scale of loss” refers to a measure of the magnitude of damage or loss associated with an event, including but not limited to financial loss, infrastructure damage, and resource depletion.

The term “training data set” refers to a collection of labeled or structured data records used by a machine learning algorithm to learn parameters of a prediction model.

The term “machine learning algorithm” refers to a computational procedure that processes training data to infer patterns or relationships and to generate a model capable of making predictions or classifications on new data.

The term “trained prediction model” refers to a data structure and associated parameters produced by a machine learning algorithm that is configured to estimate an output value, such as the degree of damage impact, based on input features.

The term “natural language prompt sentence” refers to a text sequence expressed in a human language that is input by a user to request information, ask a question, or specify a task.

The term “natural language processing engine” refers to a software component that analyzes and processes natural language text to extract structured representations, such as intents, entities, or semantic roles.

The term “question content” refers to information that represents the main intent, subject matter, and requested output contained in a user's natural language prompt sentence.

The term “target area” refers to a geographic region, location, or administrative unit that is specified or implied in the user's input and is used as a parameter for data retrieval and prediction.

The term “target disaster type” refers to a category or class of disaster events, such as storms, floods, or earthquakes, that is specified or implied in the user's input and is used as a parameter for analysis.

The term “target period” refers to a time range or temporal window specified or implied in the user's input that constrains the data and predictions relevant to the query.

The term “prompt sentence” refers to a text prepared for input to a generative artificial intelligence model that may include, in addition to a user's natural language prompt sentence, supplementary information such as statistical data, prediction results, or instructions.

The term “extended prompt sentence” refers to a prompt sentence that combines the user's natural language prompt sentence with additional structured or unstructured information, including statistical information and prediction results, for input to a generative artificial intelligence model.

The term “generative artificial intelligence model” refers to a machine-learned model that generates natural language output or other content in response to input prompts, based on learned patterns from training data.

The term “response sentence” refers to natural language text generated by the generative artificial intelligence model in response to a prompt sentence or extended prompt sentence.

The term “past disaster records” refers to disaster-related data stored in the data storage area that correspond to historical events and are used for statistical analysis and model training.

The term “prediction result” refers to an output value or set of values produced by the trained prediction model when given input features corresponding to a queried scenario.

The term “future degree of damage impact” refers to an estimated degree of damage impact that is predicted to occur under specified conditions that may arise after the time of prediction.

The term “emotion recognition processing” refers to computational processing that analyzes user-related inputs, such as text, interaction patterns, or usage history, to estimate an emotional state of the user.

The term “emotional state of the user” refers to a categorized or parameterized representation of the user's affect or mood, such as calm, anxious, confused, or confident, as inferred by the emotion recognition processing.

The term “expression format” refers to characteristics of the presentation of a response sentence, including wording style, level of technical detail, structure, emphasis, and use of summaries or lists.

The term “presentation content” refers to the substantive elements of the information presented to the user, including which topics are covered, which recommendations are emphasized, and which numerical values are highlighted or omitted.

The term “user terminal” refers to an electronic device operated by the user, such as a computing device or communication device, that is capable of sending input to and receiving output from the server.

The term “display device” refers to a hardware component of the user terminal that visually presents text, graphics, or other information to the user.

The term “format viewable on a display device” refers to a representation of information that is encoded and arranged so that the display device can render the information in a human-readable form, such as graphical user interface elements, text layouts, or structured visual components.

In one embodiment, a server executes a disaster information processing program stored in a storage device and cooperates with one or more terminals operated by users. The server includes at least one hardware processor, a main memory, a non-volatile storage device, and a network interface. The terminal includes a display device, an input device, and a communication module for connecting to the server via a communication network.

The server uses a data management software component implementing relational database management functionality to store and manage disaster-related data and meteorological data.

The server uses a statistical processing software component, such as a data-frame-based analysis library, to perform aggregation and feature generation. The server uses a machine learning library to construct and train a prediction model, and uses a generative AI model to generate natural language responses based on a prompt sentence that includes both user input and model-derived data.

The server configures the storage device to maintain multiple logical tables, including at least a disaster event table, a meteorological observation table, a region table, and a model metadata table. The disaster event table stores structured records having fields such as event identifier, disaster type, event start time, event end time, region code, number of casualties, and economic loss. The meteorological observation table stores fields such as observation time, observation location, precipitation amount, wind speed, temperature, and humidity. The region table maintains mappings between human-readable region names and internal region codes, together with geographic coordinates and administrative attributes. The model metadata table stores hyperparameters, training dates, performance metrics, and feature definitions for the prediction models.

The server uses a communication network interface to connect to multiple publicly accessible information sources, such as application programming interfaces provided by public organizations, sensor aggregators, or open data repositories. The server periodically downloads disaster-related data and meteorological data by issuing structured HTTP requests and receives data in a standard machine-readable format such as a JavaScript object notation structure. The server validates integrity and schema conformity of the received data before inserting it into the relational tables. By enforcing primary keys and foreign key relationships, the server prevents duplicate storage and ensures that disaster events and meteorological observations are consistently linked by time and region.

The server applies the statistical processing software to load subsets of the relational data into in-memory data structure objects that represent tables as column-oriented data frames. The server converts time fields into a common time zone and down-samples or up-samples observation records to fixed time intervals. The server derives new features such as accumulated rainfall over a defined window, maximum wind speed in a specified period, and population-normalized casualties. The server computes a damage impact index for each disaster event by combining normalized casualties and normalized economic loss according to a weighted formula. The server stores this impact index as an additional column in the disaster event table, enabling efficient indexing and range queries.

The server constructs a training data set for a prediction model by joining the disaster event table with the meteorological observation table on time and region keys. The server selects a set of input features that includes numerical weather parameters, categorical disaster type encoded as numerical vectors, temporal features such as month and hour of day, and region-dependent features such as population density and infrastructure vulnerability indicators. The server designates the damage impact index as the target variable to be predicted.

In one embodiment, the server uses a supervised learning algorithm based on gradient-boosted decision trees to generate a trained prediction model. The server initializes an ensemble of decision trees with specified depth, number of estimators, learning rate, and regularization parameters. The server iteratively fits each tree to the negative gradient of a loss function, such as mean squared error, computed between the current model prediction and the observed damage impact index. The server updates the model parameters by adding each new tree to the ensemble with an appropriate weight. The server evaluates the trained model using a separate validation data set and computes performance metrics such as coefficient of determination and root mean square error. The server stores the trained model parameters and associated feature-mapping information in the storage device, enabling efficient loading for subsequent inference.

In another embodiment, the server uses a neural network model as the prediction model. The server constructs a multi-layer neural network with an input layer corresponding to the defined features, one or more hidden layers with non-linear activation functions, and an output layer producing a scalar damage impact index. The server uses a loss function such as mean absolute error and applies backpropagation to compute gradients of the loss with respect to the network weights. The server updates the weights using an optimization algorithm such as stochastic gradient descent with momentum or an adaptive learning rate method. The server may apply regularization techniques, including dropout or weight decay, to improve generalization performance.

The server uses a generative AI model implemented as a large-scale neural network trained on natural language corpora. The generative AI model receives a prompt sentence as an input sequence and outputs a response sentence as a sequence of tokens. The server structures the generative AI model as a transformer-based architecture having an encoder-decoder or decoder-only configuration, multiple attention layers, and position-wise feed-forward networks. The server parametrizes the generative AI model with learned weight matrices that capture word embeddings, positional encodings, and attention parameters.

The server generates an extended prompt sentence by combining three classes of input: (1) a natural language prompt sentence directly entered by the user; (2) statistical information derived by the statistical processing software, such as average impact index, maximum historical impact, and event counts in a region and period; and (3) a prediction result obtained from the trained prediction model for specified scenario parameters. The server converts numerical values into textual descriptions and inserts them into the extended prompt sentence with explicit labels. For example, the server may construct a prompt such as:

“User prompt sentence: ‘Tell me the historical damage impact level of typhoons in Tokyo and recommend preparation steps.’ Historical data summary: From 2000 to 2020 in the specified region, the average damage impact index for typhoons is 0.65, the maximum recorded index is 0.92, the number of events is 24, total casualties are 15, and total economic loss is 1.2e11 units. Model prediction: For a strong typhoon scenario with high wind speed and heavy rainfall, the predicted damage impact index is 0.78, corresponding to a high impact level. Based on this information, explain in plain language the impact level and provide concrete preparedness measures.”

The server inputs this extended prompt sentence into the generative AI model. The generative AI model attends to both the user's original question and the numerical summaries and produces a response sentence that includes explanations, risk interpretations, and recommended actions. The server does not rely on a fixed template; instead, the generative AI model generates a context-aware response that is grounded in the statistical data and prediction result. Because the extended prompt sentence explicitly encodes structured data in textual form, the generative AI model can leverage its learned language patterns while being constrained by factual numerical content.

The server further applies an emotion recognition module that estimates a user's emotional state from interaction data. The server can derive features such as lexical indicators of anxiety or urgency from the user's input texts, response time patterns from the terminal, and frequency of repeated or escalating queries. The server uses a classification algorithm, such as a recurrent neural network or transformer encoder, to map these features to an emotional state label, for example calm, anxious, or confused. The server adjusts the response sentence presentation based on this label. For an anxious user, the server may instruct the generative AI model through the extended prompt sentence to use shorter sentences, clearer bullet points, and reassurance phrases. For a calm, expert user, the server may instruct the model to include more technical detail and numerical justification. This adaptive formatting improves comprehension and reduces cognitive load.

The server offers the terminal a response in a pre-renderable format. The server can encapsulate the response sentence, selected numerical metrics, and recommended action items into a structured payload and send it over the communication network. The terminal receives this payload and renders it on the display device using a graphical user interface. The terminal may highlight critical metrics such as predicted damage impact index and maximum historical loss using visual styles that differ depending on the impact level. The user can scroll through the content, select additional options, or enter follow-up prompt sentences.

The user operates the terminal by selecting a region and a disaster type through interactive controls and by entering a natural language prompt sentence. Example prompt sentences include:
“Tell me the historical damage impact level of typhoons in Tokyo and recommend preparation steps.”
“Explain the damage impact trend of heavy rainfall disasters in Osaka over the last 10 years.”
“Compare earthquake and flood damage impact levels in my region based on past data.” “Using past data, estimate the damage impact level of a strong typhoon in Tokyo and suggest concrete preparedness measures.”

The server uses these prompt sentences as part of the extended prompt sentence fed to the generative AI model, ensuring that the model's response stays aligned with the user's expressed intent and the latest analytical results.

The described configuration achieves technical improvements that go beyond mere automation of human tasks. The server's integration of relational database structures, feature-rich statistical aggregation, and specialized machine learning algorithms reduces computational overhead for repeated user queries. By precomputing and indexing the damage impact index and other key metrics, the server can answer queries with significantly lower latency than systems that perform ad hoc calculations for each request. The predictive model allows the server to infer impact levels for hypothetical or future scenarios without requiring exhaustive human-designed rules, thereby improving coverage and accuracy.

The server's use of extended prompt sentences that embed structured, model-derived data into the generative AI input also improves technical performance. Because the generative AI model receives explicit numeric constraints and summaries, the model is less likely to produce inconsistent or fabricated numerical statements, thereby reducing error rates in quantitative responses. The closer coupling between statistical computation modules and the generative AI model results in a more reliable data flow and reduces the need to run independent, redundant computations in the language model itself.

The server's emotion recognition and adaptive response formatting provide an additional technical effect. By tailoring output length, vocabulary complexity, and emphasis to an estimated emotional state, the server improves the effective bandwidth and clarity of information transmission over the human-computer interface. This can reduce the number of clarification queries and shorten the time needed for a user to extract actionable insights, which in turn decreases resource usage on the communication network and the server. Alternative embodiments are possible within this framework. The server can replace the gradient-boosted tree model with other supervised models such as random forests, support vector machines, or convolutional neural networks adapted to spatial features. The server can employ different generative AI architectures, including encoder-decoder transformers or mixture-of-experts models, provided that the models accept extended prompt sentences and produce natural language responses. The server can vary the data schema by adding tables for infrastructure assets, evacuation routes, or social media signals, thereby enriching the feature set for the prediction model.

In another embodiment, the server runs on a distributed cluster of computing nodes. The server partitions the disaster-related data by region or time and assigns processing tasks to multiple nodes. The statistical processing software then operates on partitioned data frames, and the machine learning training process uses distributed optimization algorithms to update model parameters across nodes. This distributed configuration improves scalability and reduces training time for very large datasets.

In yet another embodiment, the server deploys the prediction model on edge computing devices that are geographically closer to the users. The edge devices perform local inference using cached model parameters, thereby reducing round-trip latency for prediction requests.

The central server still performs periodic re-training and parameter distribution, but real-time prediction and extended prompt construction can occur near the terminal, improving responsiveness during high-load or network-constrained conditions.

By detailing the internal data structures, algorithmic components, and model architectures, and by explicitly defining how these components cooperate to acquire, store, process, predict, and present disaster-related information, this embodiment provides a concrete implementation that a skilled person can realize on standard computing hardware. The integration of these modules into a unified system produces specific technical effects in terms of processing speed, prediction accuracy, error reduction, and improved interaction quality, thereby constituting an improvement in computer-centered disaster information processing technology.

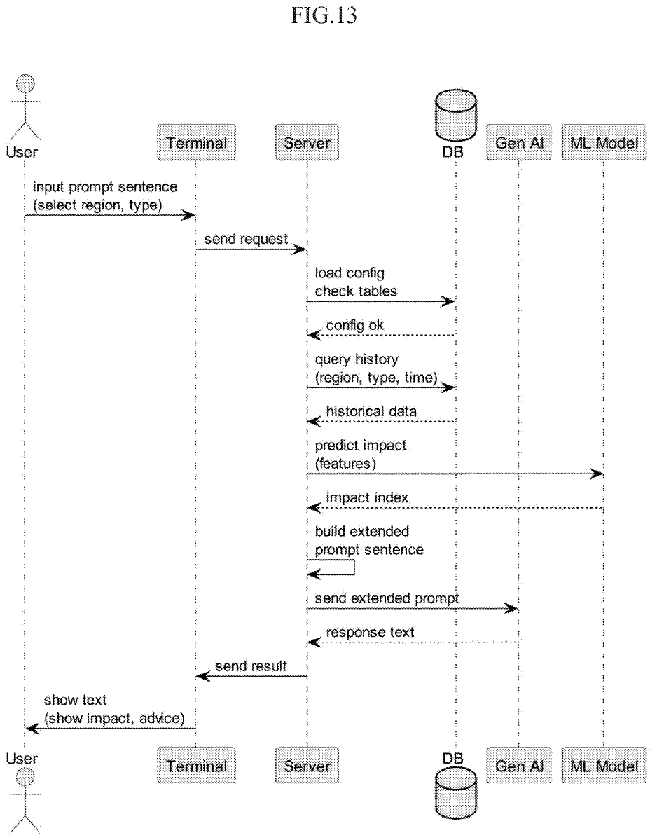

The following describes the processing flow using FIG. 13.

### Step 1:

Server initializes system configuration and resources.

Server loads configuration files that define public data source endpoints, authentication tokens, region mappings, disaster type taxonomies, and model hyperparameters.

Server establishes connections to a relational database in the storage device and verifies the presence of required tables for disaster events, meteorological observations, regions, and model metadata.

Input: configuration files and database connection parameters.

Server parses the configuration data and opens a persistent database connection pool, performing basic health checks on the communication network.

Output: in-memory configuration objects, active database connections, and ready-to-use resource handles for subsequent processing steps.

### Step 2:

Server acquires raw disaster-related data and meteorological data from publicly accessible information sources.

Server periodically sends structured HTTP requests through the communication network to external data-providing services, specifying query parameters such as region codes, time ranges, and disaster types.

Input: endpoint URLs, query parameters, and authentication tokens from the configuration objects.

Server receives responses in a machine-readable format and checks status codes, response sizes, and schema consistency.

Server discards or logs malformed responses and retains valid response payloads in a temporary storage area.

Output: validated raw data objects containing disaster-related data and meteorological data for further processing.

### Step 3:

Server parses and normalizes the acquired raw data into structured records.

Server reads the raw data objects from the temporary storage area and converts them into internal representations such as dictionaries or arrays.

Input: raw response payloads that may include nested fields for event details and weather measurements.

Server extracts required fields including timestamps, geographic descriptors, disaster type labels, casualty counts, and economic loss values, and converts timestamps into a unified time zone.

Server uses a region table to map free-text location strings to normalized region codes and fills in missing fields where default values or inference rules apply.

Output: a collection of normalized, structured records ready for insertion into the relational database.

### Step 4:

Server stores the normalized structured records in relational tables.

Server uses data management software to construct parameterized insert statements for the disaster event table and the meteorological observation table.

Input: structured records containing disaster-related and meteorological attributes with normalized region codes and timestamps.

Server checks for duplicates by querying existing keys such as event identifiers combined with data source identifiers and prevents redundant insertion.

Server inserts new records into the corresponding tables within a transaction, then commits the transaction upon success.

Output: updated relational tables with new disaster events and meteorological observations stored in the data storage area.

### Step 5:

Server prepares analysis data sets by loading table data into in-memory data structure objects.

Server issues selection and join queries against the relational database to retrieve subsets of disaster events and associated meteorological observations for one or more regions and time periods.

Input: query conditions derived from configuration (e.g., last N years, specific disaster types) and relational tables populated in Step 4.

Server loads query results into column-oriented data frames and converts column types to consistent numerical, categorical, or temporal formats.

Server filters out records with invalid or missing key attributes and ensures time alignment between event data and weather observations.

Output: cleaned and aligned data frames representing disaster events and meteorological conditions suitable for statistical processing.

### Step 6:

Server performs statistical aggregation and feature generation on the analysis data sets.

Server groups disaster events by region, disaster type, and time intervals to compute summary metrics such as total casualties, average economic loss, maximum economic loss, and event frequency.

Input: cleaned data frames containing event records and meteorological measurements.

Server normalizes casualty counts and economic losses with respect to region-specific factors such as population or baseline economic indicators.

Server computes a damage impact index for each event by combining normalized casualty values and normalized economic loss values through a weighted formula.

Server generates additional features such as time-of-year indicators, cumulative rainfall, peak wind speed, and lagged variables that capture pre-disaster conditions.

Output: enriched feature data frames that include the damage impact index and derived attributes for each event.

### Step 7:

Server constructs a training data set and trains a prediction model for the degree of damage impact.

Server selects a subset of features from the enriched data frames such as weather parameters, categorical disaster type encodings, temporal features, and region descriptors as inputs to a supervised learning algorithm.

Input: enriched feature data frames with designated target variable being the damage impact index.

Server splits the data into training and validation sets, initializes a prediction model (for example, a gradient-boosted tree ensemble or a multi-layer neural network), and iteratively adjusts model parameters to minimize a loss function such as mean squared error.

Server monitors performance metrics on the validation set and finalizes model hyperparameters and weights when convergence criteria are met.

Output: a trained prediction model with stored parameters and an associated feature mapping description recorded in the model metadata table.

### Step 8:

Server deploys the trained prediction model for inference.

Server serializes the trained model parameters and stores them in the storage device, linking them to a model identifier in the model metadata table.

Input: trained model parameters, feature mapping description, and performance metrics from Step 7.

Server loads the trained model into memory during normal operation and prepares a prediction interface that receives feature vectors and outputs predicted damage impact indices.

Server may optionally cache frequently used model components or compiled inference graphs to reduce prediction latency.

Output: an active prediction module that can be invoked whenever a request for damage impact estimation is received.

### Step 9:

Terminal provides a user interface for entering a prompt sentence and selecting contextual parameters.

Terminal displays input fields for region, disaster type, and time range, along with a text input area for a natural language prompt sentence.

Input: user interactions such as region selection from a dropdown list, disaster type selection, and text entry.

User operates the terminal and enters a prompt sentence, for example:

“Tell me the historical damage impact level of typhoons in Tokyo and recommend preparation steps.” or

“Using past data, estimate the damage impact level of a strong typhoon in Tokyo and suggest concrete preparedness measures.”

Terminal packages the selected parameters and the prompt sentence into a request payload.

Output: a structured request transmitted from the terminal to the server via the communication network.

### Step 10:

Server interprets the user request and retrieves relevant historical data.

Server receives the request payload from the terminal and parses the included region name, disaster type, time range, and prompt sentence.

Input: structured request containing at least a region descriptor, disaster type, and user-entered prompt sentence.

Server maps the region descriptor to an internal region code using the region table and constructs a query that fetches historical events and associated statistics for that region and disaster type over the specified time period.

Server loads the result set into a data frame and computes summary metrics such as average damage impact index, maximum impact index, total casualties, and aggregated economic loss for the requested conditions.

Output: historical statistical information for the specified region and disaster type, encapsulated in in-memory data structures.

### Step 11:

Server generates scenario-specific features and obtains a prediction result from the trained prediction model.

Server derives scenario parameters from the user request, such as categorizing the requested disaster intensity (e.g., “strong typhoon”) and translating these into numerical feature values consistent with the training feature space.

Input: historical statistics from Step 10, request context (region, disaster type, intensity, time frame), and the active prediction module from Step 8.

Server assembles a feature vector that includes current or assumed meteorological conditions, temporal indicators, region attributes, and any additional scenario-specific assumptions.

Server passes the feature vector to the prediction module, which computes a predicted damage impact index and, optionally, maps this index to a qualitative level such as low, medium, or high.

Output: a prediction result consisting of a numerical impact index and its corresponding qualitative category.

### Step 12:

Server estimates the user's emotional state and decides on response style parameters.

Server analyzes the user's prompt sentence and prior interaction logs to extract linguistic and behavioral features that indicate urgency, anxiety, or confidence.

Input: user prompt sentence, usage history data, and any previously stored interaction metadata.

Server uses a classification model or heuristic rules to assign an emotional state label to the user, such as calm, anxious, or confused.

Server selects response style parameters based on this label, including response length, level of technical detail, degree of repetition for key points, and tone.

Output: an emotional state label and a set of style parameters that will guide the construction and formatting of the response.

### Step 13:

Server constructs an extended prompt sentence for the generative AI model.

Server composes a text sequence that merges: (1) the user's original prompt sentence; (2) the historical statistics produced in Step 10; (3) the prediction result from Step 11; and (4) instructions reflecting the style parameters determined in Step 12.

Input: user prompt sentence, historical statistical information, prediction result, and response style parameters.

Server converts numerical metrics into descriptive phrases and inserts them in a well-defined section labeled as data summary and model prediction.

Server appends explicit instructions such as “explain in clear, concise language” or “provide detailed technical justification and numeric references,” depending on the emotional state.

Output: an extended prompt sentence that encodes both user intent and structured data in natural language format.

### Step 14:

Server obtains a natural language response from the generative AI model.

Server inputs the extended prompt sentence to the generative AI model via a model interface and initiates generation of a response sentence.

Input: extended prompt sentence produced in Step 13.

Server controls generation parameters such as maximum length, diversity, and determinism to balance completeness and clarity.

Server receives a sequence of tokens from the generative AI model and reconstructs them into a coherent text response that includes explanations of historical impact, interpretation of the predicted impact, and recommended countermeasures.

Output: a generated response sentence that is grounded in the statistical information and prediction result and aligned with the requested style.

### Step 15:

Server formats and transmits the response to the terminal.

Server combines the generated response sentence, key numerical metrics (such as average and predicted impact indices), and any structured recommendations into a response payload suitable for presentation.

Input: generated response sentence and associated numerical and categorical outputs from prior steps.

Server may add simple layout hints, section headings, or markers for bullet lists, consistent with the style parameters determined in Step 12.

Server sends the payload to the terminal through the communication network.

Output: a formatted response delivered to the terminal for display to the user.

### Step 16:

Terminal renders the response and supports follow-up interactions.

Terminal receives the response payload and interprets its content into visual elements on the display device, such as paragraphs of explanatory text, highlighted impact level indicators, and action item lists.

Input: formatted response payload from the server.

Terminal displays the generated explanation and metrics in a user-friendly layout so that the user can quickly understand the historical and predicted damage impact levels and the recommended preparations.

User reads the displayed information and, if necessary, enters additional prompt sentences such as “Compare this impact level with recent typhoons in Osaka” or “List specific items I should include in an emergency kit for a high-impact typhoon.”

Output: user comprehension of the presented information and, optionally, new user prompts that initiate another iteration of the processing flow.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional disaster information systems are typically implemented as collections of loosely coupled software modules that independently retrieve environmental data, query public information sources, and display static alerts on user devices. In such architectures, a processor in a server generally performs simple filtering or rule-based matching over incoming weather feeds and pre-defined disaster rules, and forwards fixed-format messages to user terminals. These systems lack a unified, context-aware processing pipeline that integrates time-series environmental information, historical disaster data, administrative countermeasure information, individual user location information, and dynamic user emotion state into a coherent decision framework. As a result, the systems are unable to efficiently compute region-specific risk indices at scale, generate semantically rich responses that are tailored to the user's situation, or adapt the presentation of such responses to the user's emotional condition in real time.

From a computer technology perspective, existing platforms do not provide an efficient mechanism for a processor to (i) orchestrate large-scale statistical or machine learning processing over heterogeneous disaster-related datasets, (ii) encode the results of such processing into machine-constructed prompt sentences for a generative information processing model, and (iii) control the behavior of the generative model so that its natural language output is aligned with both system-level risk analytics and user-level emotion analytics. Current server-side architectures also do not tightly integrate route search computation with generative response synthesis, thereby requiring multiple disjoint services and manual integration at the application layer, which increases latency, complexity, and resource usage.

Moreover, conventional systems handle user queries and emotional feedback in an ad hoc manner, often on the client side, and do not provide a processor-centric mechanism to use emotion estimation results to dynamically adjust the content, order, and granularity of information delivered to the user. This leads to inefficiencies in processor utilization, duplicated computation across services, and suboptimal user experience, especially under high-load conditions when many users request disaster guidance simultaneously. There is therefore a need for an improved system architecture and processing method in which a processor is configured to coordinate large-scale data processing, context-sensitive prompt sentence construction for a generative AI model, emotion-aware response adaptation, and integrated route calculation, thereby improving the operation, efficiency, and technical capability of the underlying computer system itself.

The specific processing by the specific processing unit 290 of the data processing device 12 in Application Example 2 is realized by the following means.

The present invention provides a server comprising a processor configured to acquire, based on user location information and environmental information, disaster-related information and to calculate a disaster risk for a region by obtaining time-series environmental information and disaster-related information from an external information provision apparatus, integrating the information with past disaster history information, and storing the integrated information as accumulated data; to execute large-scale information processing including statistical processing or machine learning processing on the accumulated disaster history information and environmental information to calculate, for each region, a damage impact index and a disaster risk level; to access public information sources provided by an administrative organization or a public organization, automatically collect disaster-related information including shelter information and countermeasure information by using an information acquisition process, structure the collected information, and store the structured information in association with the accumulated data; to analyze, by using natural language processing, an inquiry sentence acquired from a user terminal, extract an inquiry intent, a target region, a target disaster type, and a temporal condition, and generate inquiry context information associated with the disaster risk level, the shelter information, and the countermeasure information; to construct, by using the inquiry context information and user emotion state information as inputs, a prompt sentence that instructs a generative information processing model to generate an answer sentence, and input the prompt sentence to the generative information processing model so as to cause the generative information processing model to generate a natural language output; to estimate a user emotion state by using an emotion state estimation unit that executes emotion analysis processing based on user character information, user audio information, or user image information, and adjust, based on the emotion state, at least one of a representation style of the prompt sentence, an information amount of the answer sentence, and a presentation order of information in the answer sentence; and to integrate the answer sentence obtained from the generative information processing model with the shelter information and evacuation route information obtained by a route calculation process, generate disaster risk explanation information, action instruction information, and evacuation guidance information to be presented to the user, and transmit the generated information to the user terminal. This enables the computer system to perform an integrated, processor-controlled pipeline in which heterogeneous disaster-related data are transformed into structured analytics, encoded into context-rich prompt sentences for a generative AI model, and converted into emotion-adaptive guidance combined with computed evacuation routes, thereby improving processing efficiency, reducing latency, and enhancing the technical functionality of disaster information services implemented on the server.

The term “user location information” refers to information indicating a geographic position of a user, including but not limited to coordinates such as latitude and longitude acquired from a positioning function of a terminal or a communication network.

The term “environmental information” refers to information representing physical or environmental conditions around a region, including but not limited to weather conditions, temperature, precipitation, wind, and disaster-related alerts obtained from an external information provision apparatus.

The term “disaster-related information” refers to information concerning natural or man-made disaster events, including but not limited to warnings, advisories, damage reports, hazard levels, and associated contextual data used for assessing disaster risk.

The term “external information provision apparatus” refers to an information processing apparatus or service, accessible via a communication network, that provides environmental information, disaster-related information, or other public data through an interface such as an application programming interface or a data feed.

The term “time-series environmental information” refers to environmental information that is organized or recorded in chronological order so that variations over time can be analyzed by the processor.

The term “disaster history information” refers to stored information describing past disaster events, including event time, location, type, intensity, and observed damage, which is used as reference data for risk analysis.

The term “accumulated data” refers to combined and stored information obtained by integrating newly acquired data, including environmental information and disaster history information, into a persistent data storage structure for later analysis.

The term “large-scale information processing” refers to processing that handles a large amount of data or complex data structures, and that may involve distributed processing, batch processing, or high-volume computation performed by the processor.

The term “statistical processing” refers to processing in which the processor applies statistical techniques, such as aggregation, averaging, regression, or threshold comparison, to data in order to derive indices or measures.

The term “machine learning processing” refers to processing in which the processor applies a trained model or an algorithm that learns patterns from data, such as classification, clustering, or regression, to infer or predict values including a disaster risk level.

The term “damage impact index” refers to a numerical or categorical indicator computed from disaster history information and environmental information that represents an estimated level of damage or impact associated with a disaster in a region.

The term “disaster risk level” refers to a classification or quantification of the likelihood or potential severity of a disaster in a region, derived from damage impact indices and other analytic results.

The term “public information source” refers to an information source that is published or made available by an administrative organization or a public organization through a network or a document, including web pages and open data repositories.

The term “administrative organization” refers to an organization responsible for public administration, including but not limited to national, regional, or local government bodies that issue disaster-related announcements or countermeasures.

The term “public organization” refers to an organization that provides services or information for public benefit, including but not limited to governmental agencies, municipal offices, and publicly funded institutions.

The term “shelter information” refers to information about facilities designated as evacuation or refuge locations, including attributes such as name, address, capacity, availability period, and accessibility status.

The term “countermeasure information” refers to information describing actions, plans, or policies intended to prevent, mitigate, or respond to disaster impacts, including evacuation orders, safety instructions, and infrastructure measures.

The term “information acquisition process” refers to a process executed by the processor to obtain data from external or public information sources, including operations such as accessing a network resource, downloading a document, or retrieving data via an interface.

The term “structured information” refers to information that has been transformed into a predefined data format or schema, such as records with fields for type, location, time, and content, enabling efficient storage and retrieval.

The term “natural language processing” refers to a set of techniques by which the processor analyzes text expressed in human language, including tokenization, part-of-speech tagging, entity extraction, and intent detection.

The term “inquiry sentence” refers to a natural language text received from a user terminal that expresses a question, request, or instruction from the user regarding disaster information or guidance.

The term “inquiry intent” refers to a representation of the purpose or goal of an inquiry sentence, such as requesting a risk evaluation, asking for nearest shelters, or asking for recommended actions.

The term “target region” refers to a geographic area that is the subject of an inquiry or analysis, which may be determined from user location information or from location expressions contained in an inquiry sentence.

The term “target disaster type” refers to a classification of disasters to which an inquiry or analysis pertains, such as earthquake, flood, storm, or other hazard categories.

The term “temporal condition” refers to a condition related to time that is extracted from an inquiry or context, such as a specific date, time period, or future interval for which risk or guidance is requested.

The term “inquiry context information” refers to information generated by the processor that combines the inquiry intent, target region, target disaster type, temporal condition, and associated risk and countermeasure data into a structured representation.

The term “user emotion state information” refers to information representing an estimated emotional condition of the user, such as calm, anxious, or panicked, obtained through emotion analysis processing.

The term “prompt sentence” refers to a text or instruction sequence constructed by the processor and supplied as input to a generative information processing model, which specifies a task, context, or constraints for generating an answer sentence.

The term “generative information processing model” refers to an information processing model that, in response to an input sequence including a prompt sentence, generates natural language text or other content based on learned patterns.

The term “natural language output” refers to text generated by the generative information processing model in a human language, such as an answer sentence or explanation intended to be presented to the user.

The term “emotion state estimation unit” refers to a functional unit, implemented in hardware, software, or a combination thereof, that executes emotion analysis processing to estimate a user's emotion state from input data.

The term “emotion analysis processing” refers to processing that analyzes user character information, user audio information, or user image information to infer an emotional condition, using techniques such as pattern recognition or machine learning.

The term “user character information” refers to textual data originating from user input, such as characters forming words, sentences, or messages entered via a terminal interface.

The term “user audio information” refers to sound data obtained from a user, such as speech recorded through a microphone of a terminal, which can be used for emotion or content analysis.

The term “user image information” refers to image or video data that captures at least part of a user, including facial expressions or posture, obtained by an image capture device of a terminal.

The term “representation style of the prompt sentence” refers to characteristics of how a prompt sentence is expressed, including but not limited to length, tone, level of detail, and use of bullet points or enumerated instructions.

The term “information amount of the answer sentence” refers to a quantity or level of detail of information contained in an answer sentence, such as number of steps, length of explanation, or breadth of topics covered.

The term “presentation order of information” refers to the sequence in which individual pieces of information, such as steps or items, are arranged and displayed in an answer sentence or guidance output.

The term “evacuation route information” refers to information describing a route from a user's location to a shelter or safe place, including ordered geographic positions, path segments, and estimated travel times.

The term “route calculation process” refers to a process executed by the processor to compute an evacuation route based on user location information, shelter information, and optionally environmental or hazard constraints.

The term “disaster risk explanation information” refers to information that explains a disaster risk level, its causes, and its implications to the user in natural language form.

The term “action instruction information” refers to information that specifies recommended or required actions for the user to perform, such as preparation steps or evacuation instructions.

The term “evacuation guidance information” refers to information that assists the user in moving from a current location to a safer location, including directions, route descriptions, and associated safety notes.

The term “user terminal” refers to an information processing device operated by a user, such as a mobile communication device, portable computing device, or other client device capable of communicating with the server.

In one embodiment, a server executes a disaster information support program on a processor that is connected to a memory device, a network interface, and a mass storage device. The server runs an operating system, such as a general-purpose server operating system, and application software implemented, for example, in a high-level programming language. The server communicates with a plurality of terminals through a communication network. Each terminal is implemented as a mobile communication device or a portable computing device that includes a positioning unit, a display unit, an input unit, a microphone, a camera, and a wireless communication unit. A user operates the terminal to submit inquiries, provide consent for location and emotion analysis, and view guidance.

The server stores in the mass storage device multiple software modules, including a data collection module, a large-scale analysis module, a natural language processing module, a generative AI interface module, an emotion estimation module, a route calculation interface module, and a response synthesis module. The server further stores in a database or a distributed file system a plurality of datasets, including time-series environmental information, disaster history information, shelter information, countermeasure information, and user context information.

The server uses the data collection module to obtain environmental information and disaster-related information from external information provision apparatuses. For example, the server uses an HTTP client library to call a weather data interface and a disaster alert data interface, periodically retrieving data formatted in a structured representation such as JSON or CSV.

The server converts these responses into internal data structures, such as records with fields for timestamp, geographic coordinates, event type, and parameter values (for example, rainfall, wind speed, or alert category), and stores the records in a time-series storage area in a database or in a distributed file system, such as a distributed storage system.

The server uses the data collection module to obtain disaster history information from publicly available repositories, for example by periodically downloading batch datasets or by querying historical data interfaces. The server normalizes the acquired disaster history information into a unified schema having fields for event identifier, region identifier, event type, severity, and observed damage measures. The server then integrates this information with the time-series environmental information and stores the integrated dataset as accumulated data.

The server executes the large-scale analysis module on the accumulated data using a data processing framework, such as a distributed processing framework, to perform statistical processing and machine learning processing. The server uses structured records as input to aggregation operations, including grouping by region and event type, computing statistics such as maximum values, averages, variance, and frequency of events, and calculating intermediate indices, such as a normalized damage impact index for each region and event category. The server additionally trains and executes a predictive model for estimating a disaster risk level for each region. In one example, the server uses a gradient-boosted decision tree model or a feedforward neural network model, where features include recent rainfall totals, forecasted meteorological parameters, terrain category, and historical event frequencies. The server stores model parameters and computing instructions in the memory, and loads them into the processor when running risk estimation.

The server uses the large-scale analysis module to write, into a structured risk index table, for each region, a mapping from region identifier to damage impact index and to a discrete or continuous disaster risk level. By computing these indices in a batch or streaming manner on a distributed data structure, the server reduces per-request computation at the time of user inquiries and thereby improves processing throughput and latency characteristics of the system.

The server uses a web-scraping subsystem as part of the data collection module to access public information sources provided by administrative organizations or public organizations.

The server holds in the database a list of target resource identifiers (such as web addresses) and associated extraction rules (such as HTML element paths or text patterns). The server uses a headless browsing component to obtain the full content of each resource, including dynamically generated sections. The server then uses a parsing library to traverse the document object model and apply predefined or learned patterns to extract shelter information and countermeasure information. The server encodes each extracted item into a structured record containing fields such as facility name, geographic coordinates, capacity indicator, status, effective date, and applicable disaster type, and stores these records in a shelter information table and a countermeasure information table that are logically linked to the region identifiers used by the risk index table.

The server uses the natural language processing module to process an inquiry sentence received from a terminal. When the user enters text via a keyboard, or when the terminal converts speech to text and transmits the text to the server, the server tokenizes the inquiry sentence, performs part-of-speech tagging, and applies named-entity recognition to identify geographic expressions, disaster-related terms, temporal expressions, and other key phrases.

The server uses an intent classification algorithm, such as a neural network-based classifier or a support vector machine, trained on labeled inquiries, to assign an inquiry intent label (for example, risk evaluation request, nearest shelter search, evacuation route guidance, or preparation advice). The server extracts a target region, a target disaster type, and a temporal condition based on the entities and intent label. The server combines these extracted elements with the current risk level, shelter information, and countermeasure information corresponding to the relevant region, and generates inquiry context information as a structured data object, such as a key-value map or a data record, that encapsulates the relevant analytic and situational context.

The server uses the emotion estimation module to determine a user emotion state. The terminal, with user consent, collects user character information (such as free-form text messages), user audio information (such as voice waveforms), and optionally user image information (such as facial images). The terminal may perform local pre-processing, such as extracting a spectrogram or a compact facial feature vector using a lightweight model, and sends the resulting data to the server. The server uses an emotion estimation unit implemented as a neural network model, which may be, for example, a recurrent neural network for text, a convolutional neural network for audio spectrograms, or a convolutional network for facial images. The server uses word embeddings or other text features for the text input, and frequency-domain features or learned feature maps for audio and image inputs.

The server computes an emotion probability vector over categories such as calm, anxious, panicked, and angry, using a softmax output layer. During training, the server uses labeled datasets of user text, speech, and facial expressions with annotated emotion labels, and applies a supervised learning procedure that minimizes a cross-entropy loss function with respect to emotion categories by updating network weights via gradient-based optimization.

After deployment, the server executes this trained model on incoming user data to produce an estimated user emotion state and corresponding confidence scores. The server stores the emotion state in a user emotion table linked with the user identifier.

The server uses the generative AI interface module to construct a prompt sentence for a generative AI model. The server selects a template structure for the prompt sentence based on the inquiry intent and the estimated emotion state. For example, the server selects a concise, step-oriented template when the emotion state indicates panic, and a more explanatory template when the emotion state indicates calm. The server retrieves from the risk index table and disaster history table numeric and textual summaries, such as regional damage impact indices, historical maximum rainfall events, and representative past scenarios. The server embeds these summaries into the prompt sentence along with the user's current risk level, relevant shelter information, and specific conditions from the inquiry context information.

In one example, when the user is located in a region that has experienced frequent flooding during high rainfall and asks about current typhoon risk, the server generates a prompt sentence such as:

“You are a disaster response assistant. Past typhoon data for this region show frequent flooding when 3-hour rainfall exceeds a threshold value. The current forecast indicates rainfall above this threshold and strong winds. The user is anxious. Based on this, evaluate the current disaster risk level for the user's area and provide three concise, step-by-step actions the user should take now. Use short, clear sentences suitable for a mobile phone screen.”

In another example, when an administrative organization has opened a new shelter, the server constructs a prompt sentence such as:

“A new evacuation shelter has been opened at a specified facility in the user's ward, starting from a specified date. The user lives within a short distance of this facility. Explain briefly why going to this shelter during an earthquake improves the user's safety, and give two simple instructions on how to prepare before leaving home. Use a reassuring and calm tone.”

The server passes the constructed prompt sentence as input to the generative AI model, which is implemented as a multi-layer neural network model trained on large-scale text corpora. The generative AI model may use a transformer-based architecture with self-attention layers, positional encodings, and a large number of parameters. In a training phase, an external training system uses unsupervised or supervised learning to adjust the model parameters by predicting subsequent tokens in a text sequence or by minimizing a suitable loss function, such as cross-entropy over token vocabulary. In operation, the server calls an inference interface of the generative AI model with the prompt sentence and decodes the output token sequence as an answer sentence.

The server uses the generative AI interface module to set generation parameters, such as maximum token count and sampling temperature, to control answer length and variability.

The server receives the answer sentence from the generative AI model as a sequence of tokens, decodes them into text, and forwards the text to the response synthesis module. The server does not merely replace human drafting; instead, the server uses its analytic modules to constrain and structure the generative process. By embedding the analytically computed damage impact indices and representative historical events in the prompt sentence and by regulating the output length and tone based on emotion state, the server steers the generative AI model to produce responses that are consistent with the system's internal quantitative analysis, thereby improving the reliability and technical quality of the generated guidance.

The server uses the route calculation interface module to obtain evacuation route information.

The server retrieves the user location information from the user context table and selects one or more shelters from the shelter information table based on distance and status fields. The server uses a route computation service, such as a pathfinding interface, to compute a route from the user's current coordinates to the selected shelter coordinates, optionally providing constraint parameters such as transport mode or hazard avoidance. The server receives a route representation in the form of polylines or ordered lists of waypoints and travel time estimates, and stores this route representation as evacuation route information associated with the user and the selected shelter.

The server uses the response synthesis module to integrate multiple sources of information into a final output. The server combines the answer sentence from the generative AI model, the disaster risk level, the damage impact index, the shelter information, and the evacuation route information. The server may parse the answer sentence to identify stepwise instructions or bullet-like segments using text segmentation rules, and may add structured annotations such as urgency level or category labels (evacuation, preparation, communication). The server adjusts the structure and volume of information presented based on the emotion state: for example, the server may present only the top three most critical steps in a high-panic condition, and provide a “more details” option for calm users. The server formats the integrated information as a structured data response, such as a response object containing text fields, route vectors, and display parameters, and sends the response to the terminal over the network.

The terminal receives the response from the server and uses its display unit and user interface logic to present the disaster risk explanation information, action instruction information, and evacuation guidance information. The terminal displays, for example, a color-coded risk indicator, the step-by-step instructions generated under control of the server and the generative AI model, and a map with the evacuation route overlaid. The terminal may also display shelter details, including distance and capacity indicators, and provide interactive controls for initiating navigation or requesting more details. The terminal may use local map rendering libraries to convert the polyline route representation into on-screen graphical paths. The user interacts with the terminal by reading the displayed information, following the route, and entering additional inquiries as needed. The user may request specialized advice by entering follow-up questions. For instance, the user may type “What should I pack if I have a baby?” or “Is it still safe to stay at home?” When the terminal sends these questions to the server, the server again performs natural language processing, updates the inquiry context information, constructs a targeted prompt sentence, and calls the generative AI model to generate refined guidance, such as a list of infant care items or home safety checks. In this manner, the server uses iterative, context-sensitive prompt sentence construction and response integration to provide individualized and technically grounded guidance.

By integrating large-scale data analysis, emotion estimation, prompt sentence construction, generative AI inference, and route computation within a unified server-centric architecture, the system achieves technical improvements over conventional systems. The server reduces repeated per-query computation by precomputing region-level risk indices, uses high-dimensional feature extraction and trained models to estimate emotion and risk with higher accuracy than heuristic rules, and reduces communication load by transmitting compact structured data rather than extensive raw datasets to terminals. The server improves processing speed and scalability by employing distributed processing frameworks for batch analytics, and improves answer precision by constraining the generative AI model with machine-constructed contextual prompts rather than unstructured user input. The server further enhances the technical operation of terminals by providing route and guidance data that are already optimized for the user's emotional state and context, enabling simplified rendering logic on the terminal side.

In alternative embodiments, the server may use different model architectures for the generative AI model, such as recurrent neural networks or encoder-decoder models, or may select between multiple models based on resource availability or language. The server may also use different emotion detection inputs, such as physiological signals from sensors, and may use different types of features or training regimes, such as semi-supervised learning or data augmentation for rare emotion classes. The server may maintain different data structures for accumulated data, such as graph-based representations linking events, regions, and shelters, enabling graph-based propagation of risk levels. The route calculation interface may be replaced or supplemented by an internal pathfinding engine operating on a local road network representation. In all such variations, the server continues to perform the integrated functions of analytic data processing, prompt sentence generation, emotion-based adjustment, and combined route and guidance delivery, thereby providing a technical implementation that can be realized by a person skilled in the art based on the description herein.

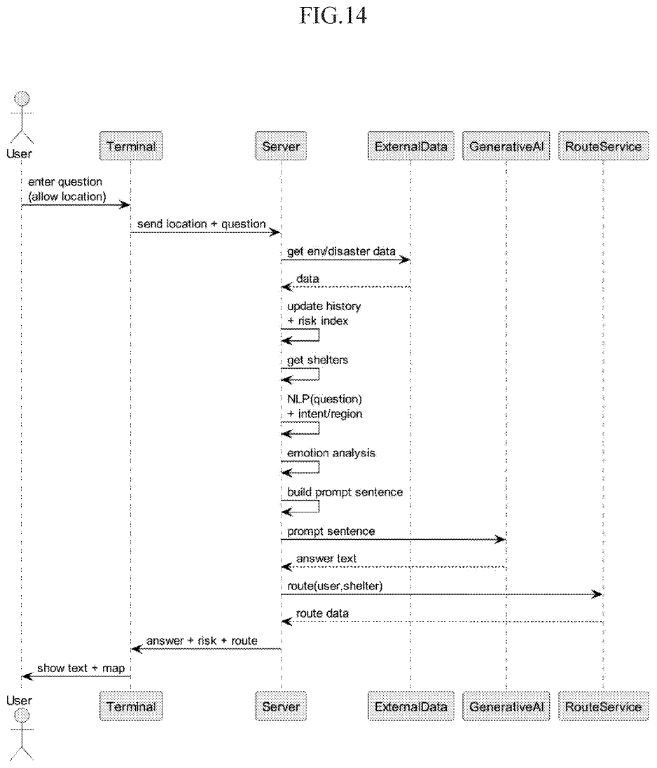

The following describes the processing flow using FIG. 14.

### Step 1:

Server acquires and stores external environmental and disaster data.

Input: data streams from external information provision apparatuses (for example, weather interfaces, disaster alert interfaces) containing time-stamped measurements and alerts. Server sends periodic HTTP requests including region identifiers or geographic coordinates, receives responses in structured formats, and parses the responses into internal records with fields such as timestamp, latitude, longitude, event type, and parameter values. Server normalizes units (for example, converting rainfall to a standard unit), validates ranges, and discards corrupted entries. Server then writes the cleaned records into a time-series storage area in a database or distributed file system as accumulated environmental information and disaster-related information.

Output: normalized and validated environmental records and disaster event records stored as accumulated data indexed by time and region.

### Step 2:

Server collects and integrates disaster history information.

Input: historical datasets or interfaces providing past disaster events, including event identifiers, locations, severities, and observed damages.

Server downloads batch files or queries historical data interfaces, parses the obtained data, and maps heterogeneous field names into a unified schema having standard keys such as event_id, region_id, disaster_type, severity_level, and damage_metrics. Server performs data conversion (for example, mapping region names to internal region identifiers) and resolves duplicates by applying deterministic rules (such as selecting most recent corrections). Server merges the integrated disaster history information with the environmental time series by matching on time windows and regions, and stores the combined records as disaster history information linked to environmental conditions.

Output: integrated disaster history information stored in structured tables and associated with environmental time series.

### Step 3:

Server performs large-scale analysis to compute damage impact indices and disaster risk levels.

Input: accumulated environmental information and disaster history information from Steps 1 and 2.

Server invokes a large-scale analysis module running on a data processing framework. Server loads records for each region and disaster type, groups them according to region_id and disaster_type, and computes statistical measures such as frequency, maximum intensity, average intensity, and variance. Server constructs feature vectors for each region that may include recent environmental readings, historical event frequencies, and terrain indicators, and feeds these vectors into a predictive model (for example, a trained gradient-boosted tree or neural network) to produce a continuous risk score. Server then converts the risk score into a discrete disaster risk level (for example, LOW, MEDIUM, HIGH) by applying threshold rules. Server stores, in a risk index table, for each region, the computed damage impact index and disaster risk level.

Output: per-region damage impact indices and disaster risk levels stored in the risk index table.

### Step 4:

Server collects shelter information and countermeasure information from public information sources.

Input: list of network resources (for example, web addresses) and associated extraction rules stored in configuration, and current content of public information sources provided by administrative or public organizations.

Server accesses each resource using a headless browser or HTTP client, retrieves document content, and applies parsing logic to construct a document object model. Server uses specific extraction rules, such as CSS selectors or text patterns, to locate segments that describe shelters or countermeasures. Server extracts attributes (for example, shelter name, address, capacity indicator, opening date, and applicable disaster types), performs geocoding to convert addresses into geographic coordinates, and normalizes dates and categorical values.

Server then inserts or updates structured records in shelter information tables and countermeasure information tables, linking each record to a region identifier.

Output: structured shelter information and countermeasure information stored in tables associated with regions.

### Step 5:

Terminal acquires user context and sends it to the server.

Input: user interactions on the terminal and sensor readings from the terminal, including GPS coordinates, device time, and optional device state.

Terminal uses its positioning unit to obtain current latitude and longitude, reads device time from the operating system, and may read additional context such as network type or battery level. Terminal assembles this data into a structured payload containing user_id, coordinates, timestamp, and context fields, and transmits it via a secure network protocol to the server.

Output: context message containing user location information and device state sent to the server.

### Step 6:

Server stores user context and determines the user's region.

Input: context message from the terminal containing user_id, coordinates, and associated metadata.

Server parses the message, validates the coordinate values, and writes a record into a user context table keyed by user_id. Server then maps the geographic coordinates to an internal region identifier, for example by performing a spatial lookup in a region boundary table or grid index. Server records the mapping between user_id and region_id for subsequent analysis and response generation.

Output: updated user context table with user_id, coordinates, and associated region_id.

### Step 7:

Server determines the current disaster risk level for the user's region.

Input: user's region_id from Step 6 and the risk index table from Step 3.

Server queries the risk index table using region_id as a key, retrieves the damage impact index and disaster risk level associated with that region, and optionally checks the recency of the underlying environmental data by comparing timestamps. If data are outdated, server may recompute risk or load updated environmental measurements before finalizing the risk level.

Server then stores the user-specific risk assessment in a user risk table keyed by user_id.

Output: user-specific disaster risk level and associated damage impact index stored in the user risk table.

### Step 8:

Terminal acquires user inquiry text and optional emotion-related signals and sends them to the server.

Input: user actions on the terminal, such as text entry, speech, and camera activation.

User inputs an inquiry, for example by typing a question or speaking into a microphone.

Terminal records speech and either sends raw audio to the server or converts the audio into text using a speech recognition component. Terminal may also capture facial images or process them into facial feature vectors. Terminal packs the inquiry text, audio features or raw audio (if used), and image features (if used) into a message, along with a reference to user_id, and transmits the message to the server via a network connection.

Output: inquiry message containing inquiry sentence and emotion-related signals sent to the server.

### Step 9:

Server estimates the user emotion state.

Input: inquiry message with inquiry text and optional audio or image features.

Server routes text input to a text-based emotion classifier, which may compute word embeddings and feed sequences into a recurrent or transformer-based sub-model to obtain emotion logits. Server routes audio or image features to respective models that have been trained to detect emotional cues. Server combines outputs from these models into a single emotion probability vector, for example by applying a weighted average or another fusion rule. Server selects as the emotion state the label with the highest probability, and stores this emotion state and probability vector in the user emotion table, keyed by user_id and timestamp.

Output: estimated user emotion state and associated confidence values stored and available for subsequent processing.

### Step 10:

Server analyzes the user inquiry sentence to derive inquiry context information.

Input: inquiry sentence text from the inquiry message and current user context (region_id, risk level, shelter information, and countermeasure information).

Server executes natural language processing on the inquiry sentence: tokenization, part-of-speech tagging, and named-entity recognition to identify location names, disaster terms, and temporal expressions. Server feeds derived features, such as token sequences and entity tags, into an intent classifier that outputs an inquiry intent category. Server uses rule-based or learned extraction to identify target region (from text or from region_id if unspecified), target disaster type (for example, flood or earthquake), and temporal condition (for example, “today” or “this week”). Server queries the risk index table, shelter information tables, and countermeasure information tables using region_id and disaster type to obtain current risk level, nearby shelters, and applicable countermeasures. Server composes an inquiry context object that includes the intent, target region, target disaster type, temporal condition, risk level, shelter list, and countermeasure summary.

Output: structured inquiry context information object associated with the user inquiry.

### Step 11:

Server constructs a prompt sentence for the generative AI model based on inquiry context and emotion state.

Input: inquiry context information from Step 10 and user emotion state from Step 9.

Server selects a template among multiple predefined templates according to inquiry intent and emotion category. For example, when the intent is a risk evaluation request and the emotion state is anxious, server selects a template that calls for short, directive instructions and a reassuring tone. Server retrieves numerical and textual summaries from the risk index and disaster history tables, such as damage impact indices and representative past events, and inserts them into template placeholders. Server also inserts relevant shelter information or countermeasure descriptions. Server then configures tone and length instructions in the prompt sentence according to emotion state, such as “use short, clear sentences suitable for a mobile phone screen” for panicked users or “provide more detailed explanation” for calm users.

Server thereby generates a prompt sentence, such as:

“You are a disaster response assistant. Past disaster data for this region show frequent flooding when rainfall exceeds a certain threshold. The current forecast indicates values above this threshold. The user is anxious. Based on this, evaluate the current disaster risk level for the user's area and provide three concise, step-by-step actions the user should take now. Use short, clear sentences suitable for a mobile phone screen.”

Output: a context-rich prompt sentence text configured for input to the generative AI model.

### Step 12:

Server calls the generative AI model and obtains an answer sentence.

Input: prompt sentence generated in Step 11 and generation parameters (such as maximum token count and temperature).

Server sends the prompt sentence and parameters to an inference interface of the generative AI model. The generative AI model processes the prompt sentence through its network layers and outputs a sequence of tokens representing a proposed answer. Server receives the token sequence, decodes it into text, and may perform basic cleanup, such as removing trailing incomplete sentences. The resulting answer sentence contains natural language explanation and recommendations aligned with the analytical context encoded in the prompt sentence.

Output: answer sentence text generated by the generative AI model.

### Step 13:

Server calculates evacuation route information.

Input: user location information from the user context table and shelter information from the shelter information table.

Server first selects candidate shelters near the user by executing a spatial query that filters shelters within a configured radius, and then ranks them by distance and status (for example, open or closed). Server selects one or more top-ranked shelters, retrieves their geographic coordinates, and sends an origin-destination pair to a route computation service. Server receives route data in the form of a series of geographic waypoints and associated attributes, such as total distance and estimated travel time. Server may perform further adjustments, such as filtering out segments running through areas marked as hazardous if such hazard overlays are available. Server encodes the resulting route as evacuation route information associated with user_id and shelter_id.

Output: evacuation route information, including waypoints and metadata, stored for integration with the answer sentence.

### Step 14:

Server synthesizes a combined response containing guidance, risk explanation, and route data.

Input: answer sentence from Step 12, user risk level and damage impact index from Step 7, shelter information and evacuation route information from Step 13, and user emotion state from Step 9.

Server segments the answer sentence into discrete guidance units, such as numbered steps or bullet-like segments, using text analysis rules. Server attaches metadata to each guidance unit, such as urgency or category. Server then integrates risk information and route details, for example by adding an introductory sentence summarizing the risk level and associating specific steps with route actions (“proceed to the shelter at location X”). Server applies emotion-based adaptation: if the user is panicked, server limits the number of displayed steps and places the most critical actions first; if the user is calm, server may add explanatory paragraphs drawn from countermeasure summaries. Server constructs a response object containing text fields for title and body, a structured list of stepwise instructions, and a representation of the evacuation route (for example, polyline or waypoint list), and prepares it for transmission to the terminal.

Output: integrated response object with disaster risk explanation information, action instruction information, and evacuation guidance information.

### Step 15:

Server transmits the response to the terminal and optionally triggers notifications.

Input: integrated response object from Step 14 and notification criteria (for example, thresholds on risk level or changes in shelter status).

Server sends the response object to the terminal using an application-level protocol over the network. If the risk level meets or exceeds a notification threshold or if new shelter information has become available, server constructs a notification payload containing a brief summary and sends it to a push notification service, which delivers the notification to the terminal.

Output: response data delivered to the terminal and, when appropriate, push notification payload delivered to the terminal.

### Step 16:

Terminal presents the guidance and route information to the user.

Input: response object and any notification payload received from the server.

Terminal parses the response object into display components. Terminal renders the title and textual guidance on the display unit, presenting step-by-step instructions according to the order specified by the server. Terminal uses a mapping component to draw the evacuation route on a map, using the waypoints or polyline, and highlights the selected shelter location.

Terminal may also show risk level indicators and summary risk explanation text. If a notification payload is received, terminal displays it as a banner or alert, and, upon user interaction, opens the corresponding screen populated with the detailed response data.

Output: visual and, optionally, audio presentation of disaster risk, actions, and route guidance to the user.

### Step 17:

User reviews the information and optionally issues follow-up inquiries.

Input: information displayed on the terminal, including instructions, route, and risk explanations.

User reads the guidance, follows the indicated route if evacuation is advised, and may enter new questions reflecting specific needs or concerns (for example, questions about family members, pets, or special medical conditions). User inputs text or speech on the terminal, causing new inquiry messages to be sent to the server.

Output: new user inquiries and interactions that serve as inputs to repeat Steps 8 through 16 for updated or refined guidance.

The data generation model 58 is a so-called generative artificial intelligence (AI). Examples of the data generation model 58 include generative AIs such as ChatGPT® (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

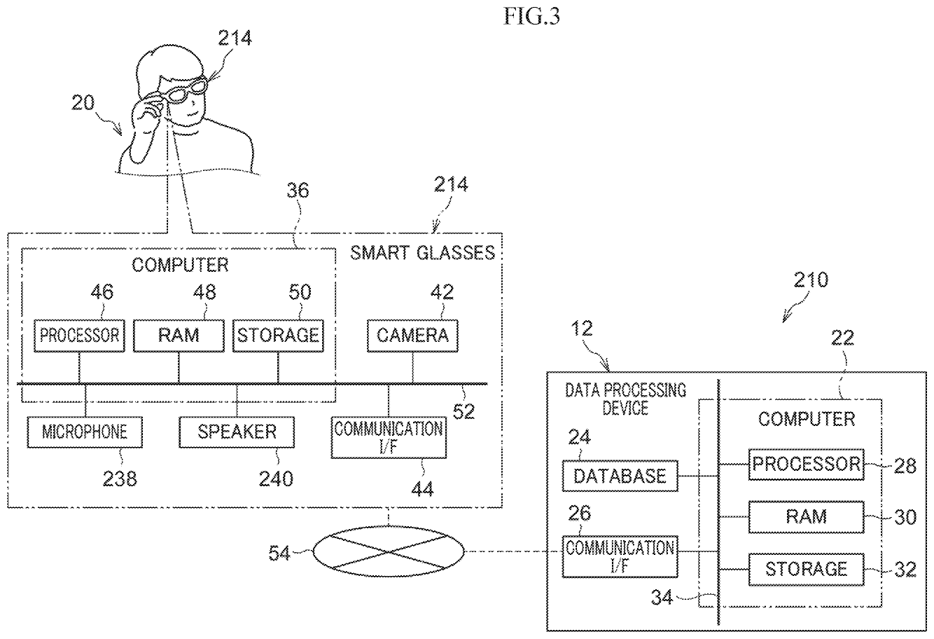

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

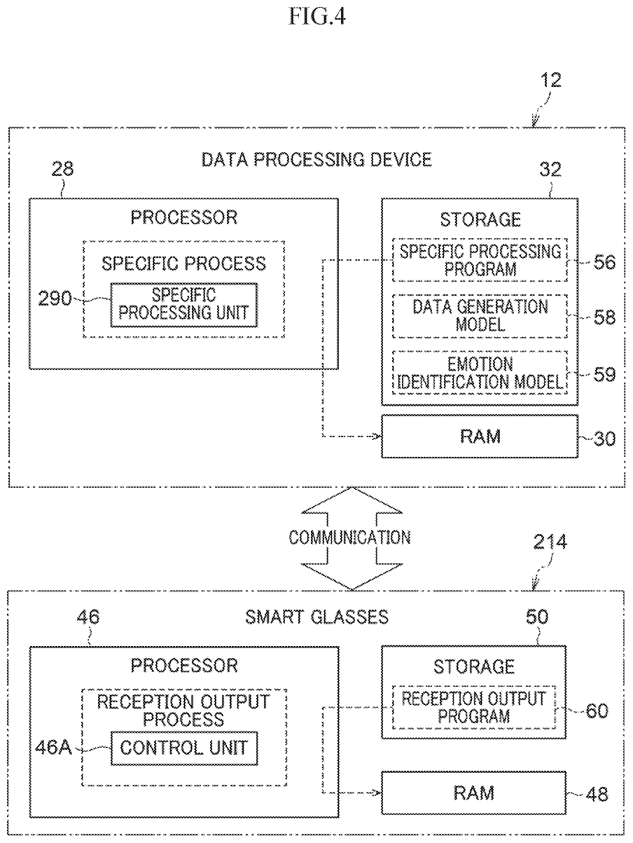

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

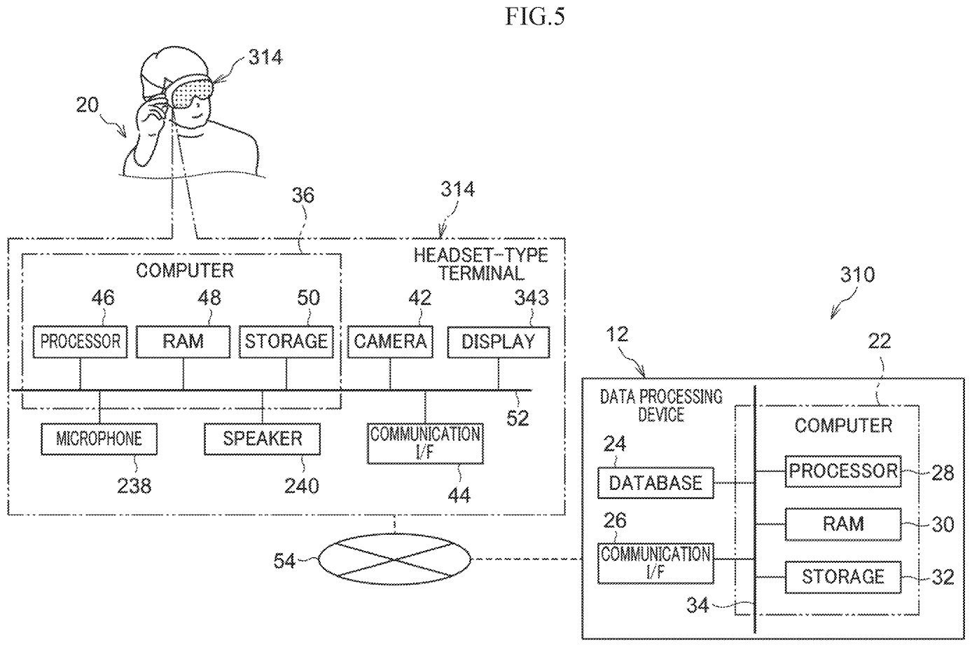

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

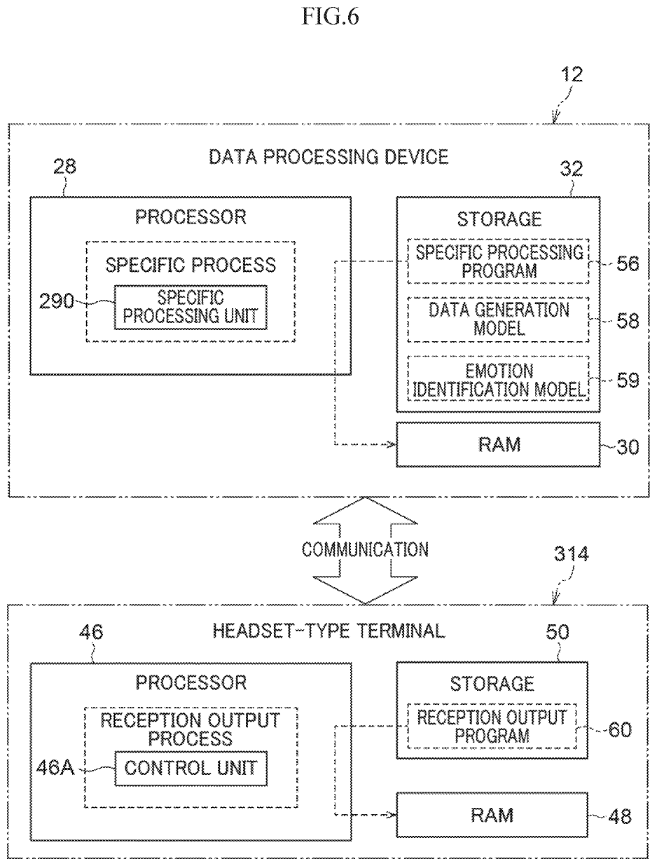

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

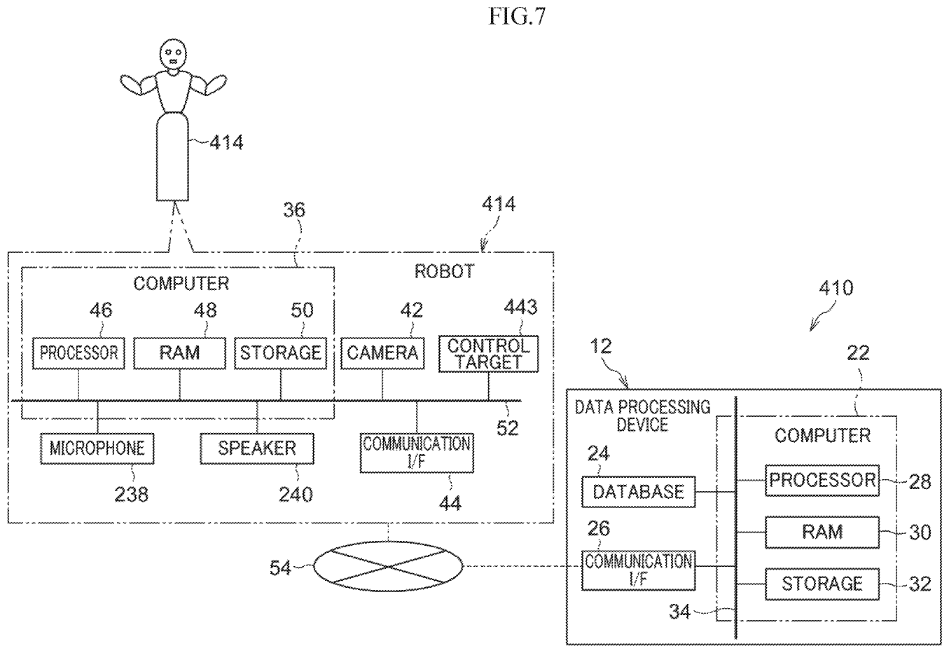

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

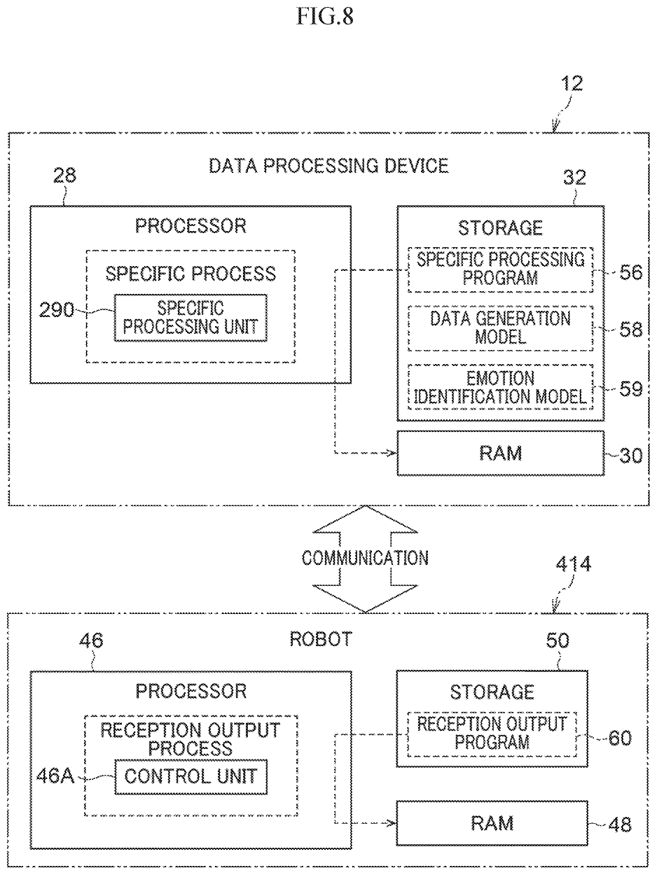

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

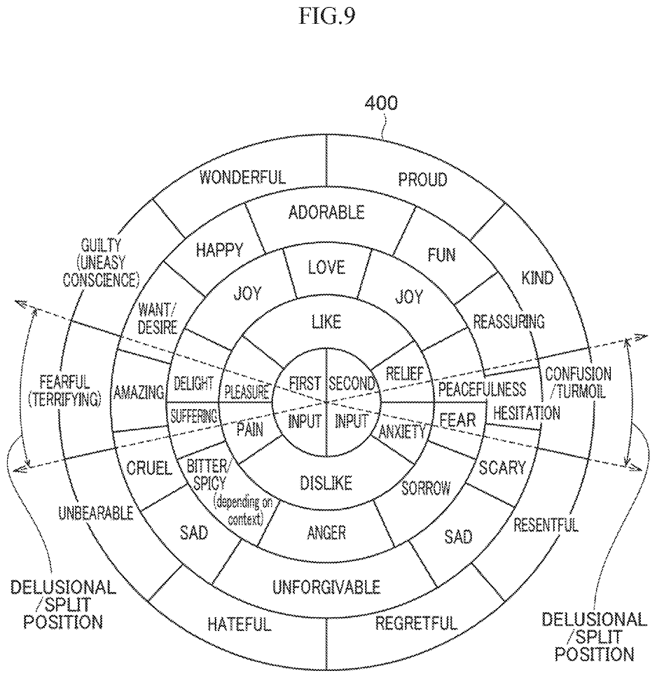

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

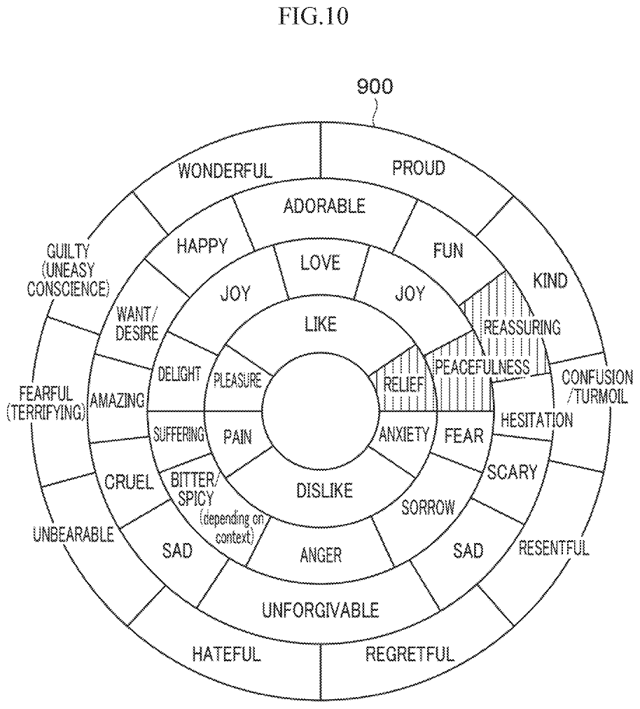

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor, a storage apparatus, a communication interface, and an output apparatus,
wherein the processor is configured to
receive, via the communication interface, inquiry information including a natural language question from a terminal operated by a user, the inquiry information being transmitted over a communication protocol, and acquire text data of the natural language question, analyze the acquired inquiry information by using a natural language processing algorithm and a language representation model so as to extract structured intent information including at least a disaster type, a temporal situation, a location, a protection target, and a requested information type,
query the storage apparatus, based on the structured intent information, the storage apparatus storing disaster history information, weather history information, countermeasure guideline information, and guideline information provided from a public organization, and acquire a plurality of information records related to the structured intent information, and select or integrate the plurality of information records according to at least one of time-series relevance, regional relevance, and reliability,
construct, based on the selected or integrated information records and the inquiry information, a prompt sentence to be input to a generative information processing model, the prompt sentence including at least role designation information, output constraint information, disaster summary information, risk factor information, and recommended countermeasure information,
supply the constructed prompt sentence as input to the generative information processing model executed on a computation apparatus, cause the generative information processing model to sequentially generate an answer sentence expressed in natural language, and perform post-processing on the generated answer sentence based on a safety rule and a formatting rule,
transmit, via the communication interface, the post-processed answer sentence as response information to the terminal, and cause the answer sentence to be output, via the output apparatus of the terminal, in a format recognizable to the user through at least one of a visual output device and an audio output device, and
estimate an emotional state of the user by using an emotion recognition processing unit, and adjust at least one of an expression content and a detail level of the prompt sentence or the answer sentence in accordance with the emotional state of the user.

### (Supplementary 2)

The system according to supplementary 1,
wherein the processor is configured to
generate, in constructing the prompt sentence, a plurality of candidate prompt sentences based on the structured intent information and the information records acquired from the storage apparatus, evaluate the plurality of candidate prompt sentences based on at least one of a predictive evaluation index output by the generative information processing model and a rule-based evaluation index, select at least one of the plurality of candidate prompt sentences according to a result of the evaluation, and input the selected prompt sentence to the generative information processing model.

### (Supplementary 3)

The system according to supplementary 1,
wherein the processor is configured to
collect, continuously or periodically, the disaster history information, the weather history information, and the countermeasure guideline information from an external information source, analyze the collected information by using a statistical processing algorithm and a machine learning algorithm, automatically generate, based on a result of the analysis, prompt sentences and candidate answer sentences corresponding to a predicted disaster scenario or to an assumed question in a state where an actual user question is not yet received, store the generated prompt sentences and candidate answer sentences in the storage apparatus, and reuse or employ the stored prompt sentences and candidate answer sentences as supplementary information in processing a real-time inquiry from the user.

### Application Example 1

### (Supplementary 1)

A system comprising a processor,
wherein the processor is configured to
obtain position information and environmental information from a user terminal, acquire disaster-related information from a storage medium based on the position information and the environmental information, and update and provide the disaster-related information in accordance with temporal changes,
analyze a natural-language inquiry sentence received from the user terminal by executing a natural language processing algorithm including at least morphological analysis, part-of-speech tagging, and key term extraction to interpret contents of the inquiry sentence, construct a prompt sentence for input to a generative AI model based on the extracted key terms, the position information, and the disaster-related information, and input the prompt sentence to the generative AI model to cause the generative AI model to generate a response sentence,
calculate evacuation route information and evacuation site information by using the position information and the disaster-related information in combination with a geographic information processing algorithm and a route search algorithm,
integrate the response sentence generated by the generative AI model with the evacuation route information and the evacuation site information to generate display data as integrated information for transmission to the user terminal, and
estimate an emotional state of a user based on emotional information obtained from the user terminal, and modify at least one of a representation format of the prompt sentence and a representation format of the integrated information in accordance with the emotional state.

### (Supplementary 2)

The system according to supplementary 1,
wherein the processor is configured to
transmit the prompt sentence to the generative AI model, receive the response sentence from the generative AI model, associate the response sentence with the evacuation route information and the evacuation site information, and store the associated information as structured data in the storage medium.

### (Supplementary 3)

The system according to supplementary 1,
wherein the processor is configured to
automatically collect and analyze disaster-related historical data and weather-related historical data by using at least one of a statistical processing algorithm and a large-scale data analysis algorithm, and dynamically determine contents and a level of detail of the prompt sentence input to the generative AI model based on an analysis result and the position information.

### Example 2

### (Supplementary 1)

A system comprising a processor,
wherein the processor is configured to
generate and provide disaster-related information that is updated over time based on user location information and current meteorological conditions,
acquire disaster-related data and meteorological data automatically from a plurality of publicly accessible information sources via a communication network and store the acquired disaster-related data and meteorological data as structured data in a data storage area of a storage device,
aggregate and transform the disaster-related data and the meteorological data stored in the data storage area by using statistical processing software to generate statistical information including indicators representing a degree of damage impact, an occurrence frequency, and a scale of loss for disasters,
generate a trained prediction model for predicting the degree of damage impact by using a machine learning algorithm based on the statistical information and the data stored in the data storage area, and store the trained prediction model in the storage device,
analyze a natural language question input by a user by using a natural language processing engine to extract a question content, a target area, a target disaster type, and a target period, and generate a prompt sentence that incorporates information including a prediction result of the degree of damage impact calculated by the trained prediction model and the statistical information,
input the prompt sentence to a generative artificial intelligence model and acquire a response sentence from the generative artificial intelligence model, the response sentence including an explanation and countermeasures based on the statistical information and the prediction result of the degree of damage impact,
perform emotion recognition processing to estimate an emotional state of the user based on expression content, input text, and usage history information obtained from the user, and adjust an expression format or presentation content of the response sentence according to the emotional state to optimize information provision, and
convert the response sentence and the prediction result into a format viewable on a display device of a user terminal and provide the converted response sentence and prediction result to the user terminal.

### (Supplementary 2)

The system according to supplementary 1,
wherein the processor is configured to
store the disaster-related data and the meteorological data acquired from the publicly accessible information sources as a plurality of table-form data sets by using data management software having a relational database management function, load the table-form data sets into data structure objects by using the statistical processing software, and perform aggregation processing and feature generation processing on the data structure objects to generate a training data set for the trained prediction model and the statistical information for presentation to the user.

### (Supplementary 3)

The system according to supplementary 1,
wherein the processor is configured to
generate an extended prompt sentence by combining a natural language prompt sentence input by the user, the prediction result of the degree of damage impact calculated by the trained prediction model, and the statistical information, and input the extended prompt sentence to the generative artificial intelligence model so that the generative artificial intelligence model generates the response sentence integrating an explanation based on past disaster records and a prediction regarding a future degree of damage impact.

### Application Example 2

### (Supplementary 1)

A system comprising a processor,
wherein the processor is configured to
acquire, based on user location information and environmental information, disaster-related information and to calculate a disaster risk for a region, by obtaining time-series environmental information and disaster-related information from an external information provision apparatus, integrating the information with past disaster history information, and storing the integrated information as accumulated data, and
execute large-scale information processing including statistical processing or machine learning processing on the accumulated disaster history information and environmental information to calculate, for each region, a damage impact index and a disaster risk level, and access public information sources provided by an administrative organization or a public organization, automatically collect disaster-related information including shelter information and countermeasure information by using an information acquisition process, structure the collected information, and store the structured information in association with the accumulated data, and
analyze, by using natural language processing, an inquiry sentence acquired from a user terminal, extract an inquiry intent, a target region, a target disaster type, and a temporal condition, and generate inquiry context information associated with the disaster risk level, the shelter information, and the countermeasure information, and
construct, by using the inquiry context information and user emotion state information as inputs, a prompt sentence that instructs a generative information processing model to generate an answer sentence, and input the prompt sentence to the generative information processing model so as to cause the generative information processing model to generate a natural language output, and
estimate a user emotion state by using an emotion state estimation unit that executes emotion analysis processing based on user character information, user audio information, or user image information, and adjust, based on the emotion state, at least one of a representation style of the prompt sentence, an information amount of the answer sentence, and a presentation order of information in the answer sentence, and
integrate the answer sentence obtained from the generative information processing model with the shelter information and evacuation route information obtained by a route calculation process, generate disaster risk explanation information, action instruction information, and evacuation guidance information to be presented to the user, and transmit the generated information to the user terminal.

### (Supplementary 2)

The system according to supplementary 1,
wherein the processor is configured to construct the prompt sentence by embedding, as summary information, the damage impact index calculated by the large-scale information processing and a representative case extracted from the disaster history information, and to control the generative information processing model so that the generative information processing model generates the answer sentence including a disaster risk evaluation and a countermeasure proposal based on the summary information.

### (Supplementary 3)

The system according to supplementary 1,
wherein the processor is configured to execute route search processing based on the user location information and the shelter information, calculate, as the evacuation route information, an optimal evacuation route for the user, present the evacuation route information in association with the answer sentence, and dynamically change a presentation format of the evacuation route information and a detail level of an explanatory sentence according to the user emotion state.

What is claimed is:

1. A system comprising:
circuitry configured to:
receive, via a communication interface coupled to a packet-switched network, inquiry information comprising a natural language question from a user terminal, and perform text acquisition and normalization on the inquiry information;
analyze the normalized inquiry information using a natural language processing algorithm and a language representation model to extract structured intent information comprising at least an event type, a temporal situation, a location, a protection target, and a requested information type;
query a storage apparatus based on the structured intent information, the storage apparatus storing event history information, environmental condition history information, countermeasure guideline information, and guideline information provided from external organizations, and select or integrate a plurality of information records according to at least one of time-series relevance, regional relevance, and reliability to produce structured factual data;
construct, based on the structured factual data and the inquiry information, a prompt sentence to be input to a generative AI model, the prompt sentence comprising at least role designation information, output constraint information, event summary information, risk factor information, and recommended countermeasure information, supply the prompt sentence to the generative AI model, cause the generative AI model to generate an answer sentence in natural language, and perform post-processing on the generated answer sentence based on a safety rule and a formatting rule; and
transmit the post-processed answer sentence as response information to the user terminal via the communication interface, and estimate an emotional state of the user using an emotion recognition processing unit and adjust at least one of an expression content and a detail level of the prompt sentence or the answer sentence in accordance with the estimated emotional state.

2. The system according to claim 1, wherein the circuitry is configured to generate a plurality of candidate prompt sentences based on the structured intent information and the information records, evaluate the plurality of candidate prompt sentences based on at least one of a predictive evaluation index output by the generative AI model and a rule-based evaluation index, and select at least one candidate prompt sentence according to the evaluation result for input to the generative AI model.

3. The system according to claim 2, wherein the predictive evaluation index is computed by applying a scoring model to each candidate prompt sentence, and the candidate prompt sentence with the highest evaluation score is selected.

4. The system according to claim 3, wherein the circuitry is configured to record each candidate prompt sentence, its evaluation score, and the corresponding generated answer sentence in an execution log in the storage apparatus for audit and model retraining.

5. The system according to claim 4, wherein the circuitry is configured to retrain the scoring model using the execution log by associating candidate prompt sentences with user feedback scores received from the user terminal.

6. The system according to claim 1, wherein the circuitry is configured to continuously or periodically collect event history information, environmental condition history information, and countermeasure guideline information from an external information source, analyze the collected information using a statistical processing algorithm and a machine learning algorithm, automatically generate prompt sentences and candidate answer sentences corresponding to predicted event scenarios, and store the generated prompt sentences and candidate answer sentences in the storage apparatus for reuse in processing real-time inquiries.

7. The system according to claim 6, wherein the circuitry is configured to retrieve stored prompt sentences and candidate answer sentences that match the structured intent information extracted from a real-time inquiry, and use the retrieved content as supplementary information in constructing the prompt sentence for the generative AI model.

8. The system according to claim 1, wherein the natural language processing algorithm applied to the inquiry information comprises morphological analysis, part-of-speech tagging, and key term extraction to generate the structured intent information as a structured data record.

9. The system according to claim 8, wherein the language representation model applies a transformer-based encoder to the normalized inquiry information to generate a contextual representation, and the structured intent information is extracted from the contextual representation using a multi-label classification head.

10. The system according to claim 1, wherein the selection or integration of the plurality of information records comprises applying a relevance scoring function that weights records based on temporal proximity to the inquiry, geographic proximity to the extracted location, and a reliability score associated with the source of each record.

11. The system according to claim 1, wherein the post-processing of the generated answer sentence comprises applying the safety rule to detect and remove content that does not conform to predetermined content constraints, and applying the formatting rule to structure the answer sentence into a format suitable for display on the user terminal.

12. The system according to claim 1, wherein the circuitry is configured to receive location information and environmental condition information from the user terminal, update the event history information in the storage apparatus based on the received location information and environmental condition information, and include the updated information in the structured factual data used to construct the prompt sentence.

13. The system according to claim 12, wherein the circuitry is configured to calculate route information and facility location information using the location information and the event history information in combination with a geographic information processing algorithm and a route search algorithm, and integrate the route information and facility location information with the response information transmitted to the user terminal.

14. The system according to claim 1, wherein the emotion recognition processing unit applies a trained emotion classification model to at least one of text features extracted from the inquiry information and biometric signals received from a sensor connected to the user terminal to estimate the emotional state.

15. The system according to claim 14, wherein the circuitry is configured to map the estimated emotional state to an expression content parameter and a detail level parameter, and apply the expression content parameter and the detail level parameter to adjust the answer sentence before transmission.

16. The system according to claim 1, wherein the circuitry is configured to cause the user terminal to output the response information through at least one of a visual output device and an audio output device via the communication interface.

17. The system according to claim 16, wherein the circuitry is configured to generate an audio representation of the response information by applying a text-to-speech synthesis technique to the answer sentence, and transmit the audio representation to the user terminal for output via the audio output device.

18. A system comprising:
circuitry configured to:
receive inquiry information comprising a natural language question from a user terminal via a communication interface, normalize the inquiry information, and apply a natural language processing algorithm to extract structured intent information;
query a storage apparatus based on the structured intent information to retrieve and integrate information records, and construct a prompt sentence incorporating the information records and the inquiry information;
supply the prompt sentence to a generative AI model to generate an answer sentence, apply post-processing based on a safety rule and a formatting rule, and transmit the post-processed answer sentence to the user terminal; and
estimate an emotional state of the user using an emotion recognition processing unit, and adjust at least one of the prompt sentence content and the answer sentence detail level based on the estimated emotional state.

19. The system according to claim 18, wherein the circuitry is configured to generate a plurality of candidate prompt sentences, evaluate each candidate using a predictive evaluation index, and select the highest-scoring candidate for input to the generative AI model.

20. A method comprising:
receiving, via a communication interface coupled to a packet-switched network, inquiry information comprising a natural language question from a user terminal, and performing text acquisition and normalization on the inquiry information;
analyzing the normalized inquiry information using a natural language processing algorithm and a language representation model to extract structured intent information comprising at least an event type, a temporal situation, a location, a protection target, and a requested information type;
querying a storage apparatus based on the structured intent information, the storage apparatus storing event history information, environmental condition history information, countermeasure guideline information, and guideline information provided from external organizations, and selecting or integrating a plurality of information records according to at least one of time-series relevance, regional relevance, and reliability to produce structured factual data;
constructing, based on the structured factual data and the inquiry information, a prompt sentence to be input to a generative AI model, the prompt sentence comprising at least role designation information, output constraint information, event summary information, risk factor information, and recommended countermeasure information, supplying the prompt sentence to the generative AI model, causing the generative AI model to generate an answer sentence in natural language, and performing post-processing on the generated answer sentence based on a safety rule and a formatting rule; and
transmitting the post-processed answer sentence as response information to the user terminal via the communication interface, and estimating an emotional state of the user using an emotion recognition processing unit and adjusting at least one of an expression content and a detail level of the prompt sentence or the answer sentence in accordance with the estimated emotional state.
